(19) United States
(12) Patent Application Publication
(10) Pub. No.: US 2025/0266458 A1
(43) Pub. Date: Aug. 21, 2025

(54) SURFACTANT-PROTECTED STRETCHABLE AND CONDUCTIVE TRIBOPOSITIVE MATERIAL AND ITS APPLICATION IN SENSORS AND ENERGY HARVESTERS

(71) Applicant: City University of Hong Kong, Kowloon (HK)

(72) Inventors: Xiangkun Bo, Kowloon (HK); Walid Daoud, Kowloon (HK); Agnes Valencia, Kowloon (HK); Hong Zhao, Kowloon (HK)

(21) Appl. No.: 19/006,458

(22) Filed: Dec. 31, 2024

Related U.S. Application Data
(60) Provisional application No. 63/555,855, filed on Feb. 20, 2024.

(51) Int. Cl. H01M 4/60; H01M 4/02; H01M 4/04

(52) U.S. Cl. CPC H01M 4/602; H01M 4/0433; H01M 4/049; H01M 2004/027; H01M 2004/028

(57) ABSTRACT

There is provided a triboelectric nanogenerator which includes a negative electrode, a negative tribolayer, a positive tribolayer, and a positive electrode. The positive tribolayer and the positive electrode are made of the same material. The material is a surfactant-protected ionic conductive material.

### FIELD OF INVENTION

The present invention relates to materials and components of triboelectric nanogenerators that generate electricity in response to motions.

### BACKGROUND OF THE INVENTION

Wearable electronics devices made of flexible materials that could produce electricity, while the devices monitor wearer motions have become a possibility in recent developments. Triboelectric nanogenerators are particularly useful for harvesting kinetic energy from motions, and do not generate any pollution.

A triboelectric nanogenerator comprises mainly tribolayers and electrodes. Electrons transfer from a positive tribolayer to a negative tribolayer that have come into contact. When the two tribolayers separate, opposite charges are induced on attached electrodes, wherein a potential is formed between the negative electrode and the positive electrode. In this case, this triboelectric nanogenerator can be used to power bulbs and electronics.

Tribolayers have good abilities to trap or denote electrons if the electrodes are conductive. Polymers containing amino and ether groups are a popular choice for positive tribolayers, while polymers comprising fluorine and cations are the usual selections for negative tribolayers.

Suitable metals and carbon have excellent conductive properties, and should be promising materials for the electrodes. However, both metal and carbon are not stretchable materials. This limits their application in actual wearable devices. Therefore, it is desirable to propose electrode materials that are stretchable, such as ionic conductors.

The two main types of ionic conductors are hydrogel conductors and solid conductors. However, use of hydrogels comes with a risk of gel leaks, while solid conductors have low conductivity. In addition, both these materials have a risk of electron or charge leakage.

Therefore, it is desirable to develop a stretchable electrode material that has high conductivity and a low tendency of charge leakage.

### SUMMARY OF THE INVENTION

According to a first aspect of the invention, there is provided a triboelectric nanogenerator, which includes:
a negative electrode;
a negative tribolayer;
a positive tribolayer; and
a positive electrode;
wherein the positive tribolayer and the positive electrode are made of the same material; and
wherein the material is a surfactant-protected ionic conductive material.

In some embodiments, the surfactant-protected ionic conductive material may include a stretchable polymer to which a surfactant and ionic salt are added.

In some embodiments, the stretchable polymer may include one or a mixture of two or more of the following: Polyvinyl alcohol (PVA), Polyethylene glycol (PEG), Thermoplastic polyurethanes (TPU), water-based polyurethane (WPU), Polyimide (PI), lignin, cellulose, starch, chitin, and protein.

In some embodiments, the surfactant may include one or more of Formula I, II, III, IV, or V as shown:

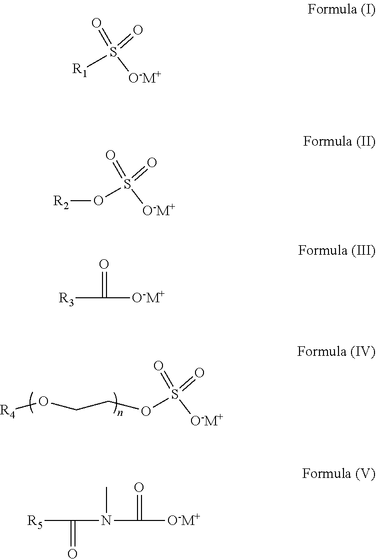

where
R₁, R₂, R₃, R₄, and R₅ independently represent a alkyl group, fluoroalkyl group, alkyl hydroxyl group, carbonyl group, alkylcarbonyl group or an ester group;
M⁺ independently represent metal ion.

In some embodiments, Formula (I-V) may be selected from one or more of the following surfactants: sodium laureth sulfate, sodium lauroyl sarcosinate, sodium dodecylbenzene sulfonate, and sodium dodecyl sulfate.

In some embodiments, the surfactant-protected ionic conductive material may be produced from a mixture in which ratio of the weight of surfactant to the polymer in the mixture is W_{surfactant}:W_{polymer}=1:20˜1:1.

In some embodiments, the ratio of the weight of surfactant to the polymer in the mixture may be W_{surfactant}:W_{polymer}=1:10˜1:2.

In some embodiments, the ionic salt may have a formula of MₓN_{y}, wherein
M, which independently represents,
   a metal element, Imidazolium, pyridinium, quaternary ammonium, quaternary phosphonium, Pyrrolidine and piperidine;
N, which represents:
   halogen elements, nitrate, sulfate, carbonate, sulfite or hydroxide, borate, oxalate, difluorooxalate, bisoxalate borate, phosphate, fluorosulfonimide, alkylfluorosulfonimide, Trifluoromethanesulfonate, tetrafluoroborate, sulfonate, Alginate, Lignosulfonate, Carboxymethyl Cellulose.

In some embodiments, the ionic salt may be selected from one or more of the following salt: 1-methylimidazole chloride, 1-methylimidazole trifluoromethanesulfonate, Lithium trifluorosulfonimide, Lithium Dimethylfluorosulfonimide.

In some embodiments, the surfactant-protected ionic conductive material may be produced from a mixture in which the ratio of the weight of salt to the polymer is from 1:100 to 1:5 (as following): Wₛₐₗₜ:W_{polymer}=1:100˜1:5. Preferably, the ratio may be Wₛₐₗₜ:W_{polymer}=1:50˜1:10.

In some embodiments, the negative tribolayer may be selected from a list comprising: Poly tetra fluoroethylene (PTFE), Fluorinated ethylene propylene (FEP), Silicon rubber, Polydimethylsiloxane (PDMS), Polyvinyl chloride (PVC), PVA (polyvinyl alcohol).

In some embodiments, the surfactant may include an amphoteric surfactant.

In some embodiments, the surfactant may be selected from one or more of the following: sodium lauryl sulfonate (SLS), sodium dodecyl sulfate (SDS), and sodium dodecyl benzene sulfonate (SDBS).

In some embodiments, the ionic salt comprises fluorine-containing ionic salt. Preferably, the ionic salt may include Lithium bis(trifluoromethanesulfonyl)imide (LiTFSI).

According to a second aspect of the invention, there is provided a method of fabricating a surfactant-protected ionic conductive material for a triboelectric nanogenerator, which includes the steps of:
a) preparing a mixture of a polymer, a surfactant, ionic salt and water;
b) stirring the mixture for a certain time;
c) providing the mixture into a mould and drying the mixture to form a film,
wherein the ratio of the weight of the surfactant to the polymer is W_{surfactant}:W_{polymer}=1:20˜1:1, and
wherein the ratio of the weight of the salt to the polymer is Wₛₐₗₜ:W_{polymer}=1:100˜1:5.

In some embodiments, the mixture may include the following:

| | | |
|---|---|---|
| WPU as polymer | 0.5 | g |
| Sodium laureth sulfate as | 0.1 | g |
| surfactant | | |
| 1-methylimidazole | 0.025 | g |
| chloride as ionic salt | | |
| water | 20 | ml |

and wherein
the step b) comprises stirring the mixture for 2 hours, and
the step c) comprises providing the mixture into a mould (dimension: length: 10 cm, width: 5 cm), and drying at 60° C. for 48 hours to form a film.

In some embodiments, the mixture may include WPS as the polymer, SDBS as the sulfactant, LiTFSI as the ionic salt, and wherein
the step b) comprises stirring the mixture for half an hour to 2 hours, and
the step c) comprises providing the mixture into a mould (dimension: diameter 9 cm), and drying at 60° C. for 12 hours to form a film.

According to a third aspect of the invention, there is provided a method of fabricating a triboelectric nanogenerator, which includes the steps of:
providing a surfactant-protected ionic conductive material layer as fabricated as provided in the second aspect of the invention, the surfactant-protected ionic conductive material layer forming a positive part;
providing a negative tribolayer and a negative electrode to form a negative part; and
attaching two pieces of foam between the positive part and the negative part to have a gap between the positive part and the negative part and to allow contact-separation between the positive part and the negative part.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 shows an embodiment of the invention which is a triboelectric nanogenerator having the tribopositive layer and electrode made of the same material.

FIG. 2 illustrates chemical structure, elemental distribution and physical properties: FIG. 2A shows a schematical diagram of SDBS and LiTFSI doped WPU (Left) and chemical structures of WPU, SDBS, and LiTFSI (Right); FIG. 2B shows FTIR curves of WPU, WS and WLS films; FIG. 2C shows concentration distribution of Na from the surface to the bulk of WLS-0.2 when looking at cross-section of WLS-0.2; FIG. 2D shows tensile stress-strain curves of WPU, WS films, and WLS-0.2; FIG. 2E shows tensile stress-strain curves of WPU, WLS-0, WLS-0.1, WLS-0.2 and WLS-0.3; FIG. 2F shows an example setup for testing relative permittivity (a), and dielectric loss of WPU, WLS-0 and WLS-0.2 (b); FIG. 2G shows relative permittivity of WPU, WLS-0, and WLS-0.2.

FIG. 3A shows XPS survey spectra for WPU, WS-0.2, WLS-0, and WLS-0.2; FIG. 3B shows elemental ratio of C, O, N; FIG. 3C shows elemental ratio of S, F, Na; FIGS. 3D-3G show C1s survey spectra of WPU, WS-0.2, WLS-0, and WLS-0.2, respectively; FIGS. 3H-3K show O1s survey spectra of WPU, WS-0.2, WLS-0 and WLS-0.2, respectively.

FIG. 4 shows KPFM results and diagram of charge transfer, in particular, FIG. 4A shows relative height in the middle line of WPU, WS-0.2, WLS-0, and WLS-0.2; FIG. 4B shows the electron-cloud-potential-well model of electrons transferring from WLS-0 to Ecoflex; and FIG. 4C shows the electron-cloud-potential-well model of electrons transferring from WLS-0.2 to Ecoflex.

FIG. 5 illustrates electric output and comparison with literature, in particular, FIG. 5A shows diagram of WPU, WS, and WLS film-based two-electrode TENG; FIG. 5B shows working mechanism of WPU, WS, and WLS film-based two-electrode TENG; FIG. 5C shows transient current curve and marked stage of releasing-released-pressing-pressed of WLS-0.2-based TENG; FIGS. 5D and 5E show V_{OC} and Q_{SC} of WPU, WS films-based TENG; FIGS. 5F and 5G show I_{SC} of WPU, WS film-based TENG and I_{SC} of WPU and WLS film-based TENGs, respectively; FIGS. 5H and 5I show V_{OC} and Q_{SC} of WPU and WLS film-based TENG; FIG. 5J shows comparison of charge density with literature; FIG. 5K shows V_{OC} stability of WLS-0.2-based TENG; FIGS. 5L and 5M show current, voltage and power density with circuit diagram inset of WLS-0.2-based TENG vs. resistance and working speed; FIG. 5N shows voltage accumulation by WLS-0.2-based TENG.

FIG. 6A shows chemical structure of SLS, SDS, and SDBS; FIGS. 6B-6D shows V_{OC}, Q_{SC}, and I_{SC} of DSS, SDS, and SDBS-based TENGs.

FIG. 7A shows an example device structure of PVA, PS-0.2, PLS-0, and PLS-0.2-based TENGs; FIGS. 7B-7D show V_{OC}, Q_{SC}, and I_{SC} of PVA, PS-0.2, PLS-0, and PLS-0.2-based TENGs.

FIGS. 8A-8C show V_{OC} cycling of WLS-0.2-based TENG: FIG. 8A for 0-10 s, FIG. 8B for 12000-12010 s and FIG. 8C for 24000-24010 s.

FIGS. 9A-9C show V_{OC}, Q_{SC}, and I_{SC} of WLS-0.2-based TENG at different working speed; FIGS. 9D-9F show V_{OC}, Q_{SC}, and I_{SC} of WLS-0.2-based TENG at different gap distance.

FIG. 10A shows diagram of EIS setup; FIGS. 10B-10F show EIS curves of WPU, WLS-0, WLS-0.1, WLS-0.2, and WLS-0.3 respectively.

FIGS. 11A-11F show conductivity and electric output, in particular, FIG. 11A shows schematical diagram of EIS test setup; FIG. 11B shows ionic conductivity of WPU and WLS films; FIG. 11C shows device structure of Cu-electrode-based TENG (upper) and WLS-0.2-electrode-based TENG (bottom); FIGS. 11D-11F show V_{OC}, Q_{SC} and I_{SC} of Cu-electrode-based TENG and WLS-0.2-electrode-based TENG.

FIGS. 12A-12K show applications of WLS-0.2-based TENG, in particular, FIG. 12A shows device structure and working mechanism of WLS-0.2-based single-electrode TENG; FIG. 12B shows diagrams of finger (b1) releasing, and bending at (b2) 30°, (b3) 60° and (b4) 90°; FIG. 12C shows comparison of V_{OC} signals with literature; FIGS. 12D-12F show V_{OC}, Q_{SC}, and I_{SC} of bending-releasing at 30°, 60°, and 90°; FIG. 12G shows schematic diagram of the working mechanism and output of a 5×5 cm² device mounted on a shoe sole; FIG. 12H shows voltage accumulation of 0.47, 1, 3.3, 4.7, and 10 μF capacitors and equivalent circuit diagram; FIG. 12I shows the 10 μF capacitor which was charged to 5 V to power a stopwatch; FIG. 12J shows the voltage accumulation curves with Ag coil circuit diagram and coil distance of 0.5 cm and 1 cm; FIG. 12K shows the voltage accumulation curves with Al plate circuit diagram and plate distance of 0.5 cm and 1 cm.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION OF SPECIFIC EMBODIMENTS

Embodiments of the invention include a triboelectric nanogenerator; wherein the triboelectric nanogenerator consists of tribolayers and electrodes.

In particular, the embodiments comprise triboelectric nanogenerators that may be stretchable, human body-compatible, high electric outputs and structure-stable, and suitable for use in flexible devices.

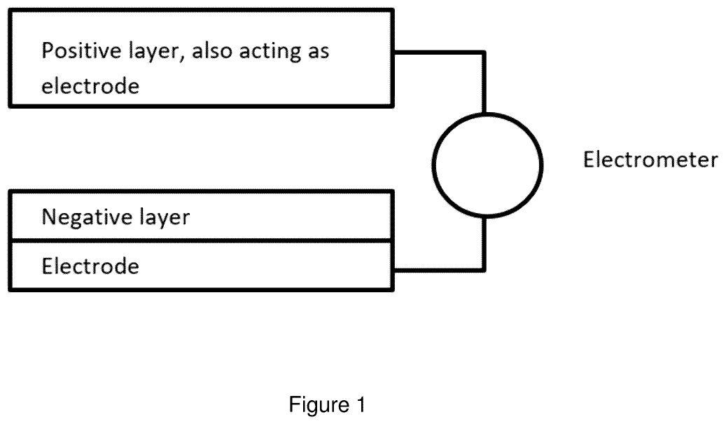

To provide triboelectric nanogenerators with such characteristics and which also resist separation of the tribolayer and the electrode, an effective method of fabricating a stretchable, ionic conductive, highly tribopositive material is proposed. This material can be used as both the tribolayer and electrode at the same time, as shown in FIG. 1, therefore preventing separation.

Many highly concentrated ionic conductor has low tribopositivity. To resolve this problem, embodiments are made with dissociated salt and stretchable polymers, i.e. fabricated by adding surfactant to avoid the negative effect of charge donation.

The surfactant is formed on the surface of a polymer film and this protects the polymer film from the negative effect of the salt. Apart from eco-friendliness, sustainability, safety and durability, this surfactant-based material has better stretchability (550% elongation at break), conductivity (5×10⁻³ mS/cm), and the assembled triboelectric nanogenerator has high electric output (open circuit voltage (V_{OC}):300 V, short circuit current (I_{SC}) 30 μA).

Such a material may be used in making devices that harvest energy from kinetic objects, especially from human body motions. Consequently, devices comprising this material are self-supplying in terms of electricity, and the types of devices that can benefit from using such a material include wearable electronics and wearable batteries. In addition, the material can be used to make devices that are useable as a sensor to monitor bending-releasing finger, elbow and knee.

The material comprises a stretchable polymer to which a surfactant and ionic salt are added, i.e.
(1) The material improves the electric output, stretchability and ionic conductivity of triboelectric nanogenerator by adding surfactant and ionic salt into a stretchable polymer.
(2) This provides a possibility that the material is useable as both the positive tribolayer and the electrode;
(3) The material includes surfactant-protected ionic conductive materials, and consists of compounds of polymer; at least one surfactant (Formula I, II, III, IV, or V) and salt.
(4) The material includes at least one of the following polymers: Polyvinyl alcohol (PVA), Polyethylene glycol (PEG), Thermoplastic polyurethanes (TPU), water-based polyurethane (WPU), Polyimide (PI), lignin, cellulose, starch, chitin, and protein.
(5) The surfactant includes: Formula I, II, III, IV, or V

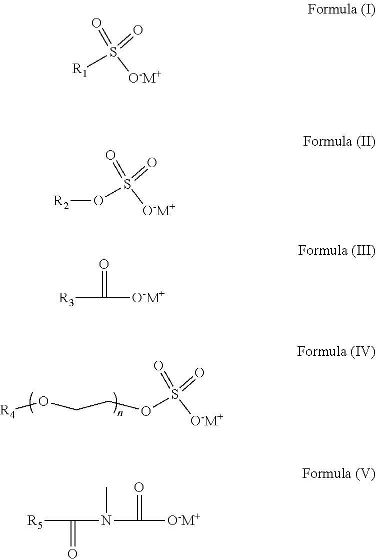

where
R₁, R₂, R₃, R₄, and R₅ independently represent an alkyl group, fluoroalkyl group, alkyl hydroxyl group, carbonyl group, alkylcarbonyl group or an ester group;
M⁺ independently represents metal ion.

Typically, any one of Formulae (I to V) comprises a surfactant selected from one or more of the following: Sodium laureth sulfate, Sodium lauroyl sarcosinate, Sodium dodecylbenzene sulfonate, and Sodium dodecyl sulfate.

Preferably, in the above surfactant-protected ionic conductive materials, the ratio of the weight of surfactant to the polymer is from 1:20 to 1:1 (as following): W_{surfactant}:W_{polymer}=1:20˜1:1. More preferably, however, the ratio is W_{surfactant}:W_{polymer}=1:10˜1:2.
(6) Formula (VI) refers to all the Formulae (I to V) where the choice of the salt includes MₓN_{y}, where
M, which independently represents,
   a metal element, Imidazolium, pyridinium, quaternary ammonium, quaternary phosphonium, Pyrrolidine and piperidine;
N, which represents:
   halogen elements, nitrate, sulfate, carbonate, sulfite or hydroxide, borate, oxalate, difluorooxalate, bisoxalate borate, phosphate, fluorosulfonimide, alkylfluorosulfonimide, Trifluoromethanesulfonate, tetrafluoroborate, sulfonate, Alginate, Lignosulfonate, Carboxymethyl Cellulose.

More specifically, the surfactant of Formula (VI) is selected from one or more of the following salt:
1-methylimidazole chloride, 1-methylimidazole trifluoromethanesulfonate, Lithium trifluorosulfonimide, Lithium Dimethylfluorosulfonimide
(9) In the above surfactant-protected ionic conductive materials, the ratio of the weight of salt to the polymer is from 1:100 to 1:5 (as following): Wₛₐₗₜ:W_{polymer}=1:100˜1:5. More preferably, the ratio is Wₛₐₗₜ:W_{polymer}=1:50˜1:10.
(9) The fabrication method of solid ionic electrode consists of one or more steps of mixing, heating, stirring and evaporation.
(10) The counterpart of the negative tribolayer is selected from Poly tetra fluoroethylene (PTFE), Fluorinated ethylene propylene (FEP), Silicon rubber, Polydimethylsiloxane (PDMS), Polyvinyl chloride (PVC), PVA (polyvinyl alcohol).

### Example 1

Fabrication of surfactant-protected ionic conductive material: 0.5 g WPU, 0.1 g Sodium laureth sulfate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 1.

Fabrication of triboelectric nanogenerator: PDMS is negative tribolayer and the surfactant-protected ionic conductive material is the conductive positive tribolayer. The surfactant-protected ionic conductive material acted as positive tribolayer and electrode simultaneously. The 10 g PDMS and 1 g curing agent (Brand: DOWSIL 184) were mixed together and poured to a mould (dimension: length: 10 cm, width: 5 cm). Then transferring them to 80° C. oven for 6 hours and the negative tribolayer was formed.

Next, negative tribolayer (PDMS) was cut to 5 cm×1 cm; positive part (surfactant-protected ionic conductive material) was cut to 5 cm×1 cm. Finally, we used two pieces of foam (thickness: 5 mm) to separate the positive part and negative part. So, the triboelectric nanogenerator was finished and taped on thumb to harvest bending-releasing energy.

The stretchability was tested by mechanical test system with the test speed of (1 cm/min). Conductivity was tested by Electrochemical Impedance Spectroscopy (EIS) method. Electric output was test via an oscilloscope.

### Example 2

Fabrication of surfactant-protected ionic conductive material: 0.5 g WPU, 0.25 g Sodium laureth sulfate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 2.

The other part of fabrication is the same as example 1.

### Example 3

Fabrication of surfactant-protected ionic conductive material: 0.5 g WPU, 0.05 g Sodium laureth sulfate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 3.

The other part of fabrication is the same as example 1.

### Example 4

Fabrication of surfactant-protected ionic conductive material: 0.5 g WPU, 0.5 g Sodium laureth sulfate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 4.

The other part of fabrication is the same as example 1.

### Example 5

Fabrication of surfactant-protected ionic conductive material: 0.5 g WPU, 0.025 g Sodium laureth sulfate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 5.

The other part of fabrication is the same as example 1.

### Example 6

Fabrication of surfactant-protected ionic conductive material: 0.5 g WPU, 0.1 g Sodium lauroyl sarcosinate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 6.

The other part of fabrication is the same as example 1.

### Example 7

Fabrication of surfactant-protected ionic conductive material: 0.5 g WPU, 0.1 g Sodium dodecylbenzene sulfonate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 7.

The other part of fabrication is the same as example 1.

### Example 8

Fabrication of surfactant-protected ionic conductive material: 0.5 g WPU, 0.1 g Sodium dodecyl sulfate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 8.

The other part of fabrication is the same as example 1.

### Example 9

Fabrication of surfactant-protected ionic conductive material: 0.5 g WPU, 0.1 g Sodium laureth sulfate and 0.05 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 9.

The other part of fabrication is the same as example 1.

### Example 10

Fabrication of surfactant-protected ionic conductive material: 0.5 g WPU, 0.1 g Sodium laureth sulfate and 0.01 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 10.

The other part of fabrication is the same as example 1.

### Example 11

Fabrication of surfactant-protected ionic conductive material: 0.5 g WPU, 0.1 g Sodium laureth sulfate and 0.1 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 11.

The other part of fabrication is the same as example 1.

### Example 12

Fabrication of surfactant-protected ionic conductive material: 0.5 g WPU, 0.1 g Sodium laureth sulfate and 0.005 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 12.

The other part of fabrication is the same as example 1.

### Example 13

Fabrication of surfactant-protected ionic conductive material: 0.5 g WPU, 0.1 g Sodium laureth sulfate and 0.025 g 1-methylimidazole trifluoromethanesulfonate were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 13.

The other part of fabrication is the same as example 1.

### Example 14

Fabrication of surfactant-protected ionic conductive material: 0.5 g WPU, 0.1 g Sodium laureth sulfate and 0.025 g Lithium trifluorosulfonimide were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 14.

The other part of fabrication is the same as example 1.

### Example 15

Fabrication of surfactant-protected ionic conductive material: 0.5 g WPU, 0.1 g Sodium laureth sulfate and 0.025 g Lithium Dimethylfluorosulfonimide were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 15.

The other part of fabrication is the same as example 1.

### Comparative Example 1

Fabrication of surfactant-protected ionic conductive material: 0.5 g WPU, 1 g Sodium laureth sulfate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 16.

The other part of fabrication is the same as example 1.

### Comparative Example 2

Fabrication of surfactant-protected ionic conductive material: 0.5 g WPU, 0.01 g Sodium laureth sulfate and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 17.

The other part of fabrication is the same as example 1.

### Comparative Example 3

Fabrication of surfactant-protected ionic conductive material: 0.5 g WPU, 0.1 g Sodium laureth sulfate and 0.2 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 18.

The other part of fabrication is the same as example 1.

### Comparative Example 4

Fabrication of surfactant-protected ionic conductive material: 0.5 g WPU, 0.1 g Sodium laureth sulfate and 0.001 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 19.

The other part of fabrication is the same as example 1.

### Comparative Example 5

Fabrication of surfactant-protected ionic conductive material: 0.5 g WPU, and 0.025 g 1-methylimidazole chloride were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 20.

The other part of fabrication is the same as example 1.

### Comparative Example 6

Fabrication of surfactant-protected ionic conductive material: 0.5 g WPU, and 0.1 g Sodium laureth sulfate were added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 21.

The other part of fabrication is the same as example 1.

### Comparative Example 7

Fabrication of surfactant-protected ionic conductive material: 0.5 g WPU was added into 20 ml water and stirred for 2 hours. Then, the mixture is poured into a mould (dimension: length: 10 cm, width: 5 cm) and dried at 60° C. for 48 hours to form a film. This surfactant-protected ionic conductive material is labelled as Sample 22.

The other part of fabrication is the same as example 1.

TABLE 1

| | | Elongation | Conductivity | | |
|---|---|---|---|---|---|
| | The name | at break of | of electrode | Electric | Electric |
| | of | electrode/ | (×10⁻³ | output | output |
| | hydrogel | % | mS/cm) | V_{OC}/V | I_{SC}/μA |
| Example 1 | Sample 1 | 550 | 5.0 | 300 | 30.0 |
| Example 2 | Sample 2 | 521 | 4.0 | 278 | 25.2 |
| Example 3 | Sample 3 | 518 | 3.9 | 276 | 24.9 |
| Example 4 | Sample 4 | 515 | 3.8 | 285 | 24.7 |
| Example 5 | Sample 5 | 513 | 3.7 | 284 | 24.2 |
| Example 6 | Sample 6 | 545 | 4.8 | 296 | 29.2 |
| Example 7 | Sample 7 | 540 | 4.7 | 294 | 28.7 |
| Example 8 | Sample 8 | 537 | 4.6 | 291 | 27.8 |
| Example 9 | Sample 9 | 508 | 3.6 | 282 | 24.0 |
| Example 10 | Sample 10 | 505 | 3.6 | 280 | 23.8 |
| Example 11 | Sample 11 | 503 | 3.4 | 278 | 23.6 |
| Example 12 | Sample 12 | 501 | 3.3 | 276 | 23.2 |
| Example 13 | Sample 13 | 532 | 4.5 | 287 | 26.5 |
| Example 14 | Sample 14 | 529 | 4.3 | 286 | 26.1 |
| Example 15 | Sample 15 | 527 | 4.2 | 283 | 25.7 |
| Comparative | Sample 16 | 402 | 2.8 | 198 | 18.8 |
| example 1 | | | | | |
| Comparative | Sample 17 | 389 | 2.6 | 191 | 18.1 |
| example 2 | | | | | |
| Comparative | Sample 18 | 281 | 2.5 | 189 | 17.6 |
| example 3 | | | | | |
| Comparative | Sample 19 | 276 | 2.3 | 184 | 17.3 |
| example 4 | | | | | |
| Comparative | Sample 20 | 273 | 2.1 | 179 | 16.8 |
| example 5 | | | | | |
| Comparative | Sample 21 | 267 | 1.9 | 168 | 15.4 |
| example 6 | | | | | |
| Comparative | Sample 22 | 210 | 0.1 | 98 | 5.6 |
| example 7 | | | | | |

As shown in Table 1, compared to example 2-5 and comparative example 5, example 1 shows the best performance of elongation at break, conductivity and electric output. These data indicate Sodium laureth sulfate is the optimal surfactant.

Compared to example 6-8 and comparative example 1-2, example 1 shows the best performance of elongation at break, conductivity and electric output. These data indicate W_{surfactant}:W_{polymer}=1:5 is the optimal ratio.

Compared to example 9-12 and comparative example 6, example 1 shows the best performance of elongation at break, conductivity and electric output. These data indicate 1-methylimidazole chloride is the optimal salt.

Compared to example 13-15 and comparative example 3-4, example 1 shows the best performance of elongation at break, conductivity and electric output. These data indicate Wₛₐₗₜ:W_{polymer}=1:20 is the optimal ratio.

Next, further embodiments of the invention are described.

### Surfactant Self-Assembly Enhances Tribopositivity of Stretchable Ionic Conductors for Wearable Energy Harvesting and Motion Sensing

Boosting stretchability and electric output is critical for high-performance wearable triboelectric nanogenerators (TENG). Herein, some embodiments of the invention propose a new approach for tuning the composition of surface functional groups through surfactant self-assembly to improve the tribopositivity, where the assembly increases the transferred charge density and the relative permittivity of water polyurethane (WPU).

Incorporating bis(trifluoromethanesulfonyl)imide (TFSI⁻) and alkali metal ions into a mixture of WPU and the surfactant forms a stretchable film that simultaneously functions as positive tribolayer and electrode, preventing the conventional detachment of tribolayer and electrode in long term usage. Further the introduction of surfactant and alkali metal ions in WPU forms a strong crosslinking network.

Resultantly, the conductivity of the crosslinked film reaches 3.3×10⁻³ mS cm⁻¹ while the elongation at break reaches 362%, which are 4.8×10⁴-fold and 1.3-fold higher than pristine WPU, respectively. Moreover, the surfactant self-assembly impedes the adverse impact of the fluorine-containing groups on tribopositivity. The self-assembled and LiTFSI-doped WPU-based TENG generates an open circuit voltage of 120 V, a short circuit current of 7.5 μA and a transfer charge of 62 nC, representing a 4-fold increase compared to LiTFSI-doped WPU-based TENG.

Consequently, the charge density reaches 155 μC m⁻², being the highest recorded for WPU and stretchable ionic conductive based TENG. The embodiments of the invention introduce a novel approach for boosting the output charge density while avoiding the adverse effect of ionic salts in solid conductors through a universal surfactant self-assembly strategy, which can be extended to other materials, such as polyvinyl alcohol. Further, the device is used to monitor and harvest the kinetic energy of human body motion.

### 1. Introduction

With the rapid development of wearable electronics and the internet of things, the demand for wearable energy supply is rapidly growing.^{[1-5]} Hence, it would be beneficial to harness the kinetic energy from human body motion for supplying power to wearable electronics. Piezoelectric nanogenerators (PENG),^{[6,7]} electromagnetic generators (EMG),^{[8,9]} and triboelectric nanogenerators (TENG)^{[10,11]} are three types of devices commonly used in the field of kinetic energy harvesting, each with their own advantages and drawbacks. In particular, in comparison to PENG, TENG offers higher electric output and a wider range of materials to select from.^{[12]} Additionally, while EMG is suitable for transforming high-frequency energy, such as wind and water flow, TENG is suited for harnessing low-frequency energy input.^{[13]} TENG is composed of tribolayers and electrodes, and its charge generation is based on the coupling of triboelectrification and electrostatic induction. When an external force is exerted on the device, the positive and the negative tribolayers come into contact, and electrons are transferred from the positive to the negative tribolayer. When the tribolayers separate, opposite charges are inducted on the electrodes, forming a potential difference between the positive and negative electrodes. While TENG shows great potential for harvesting energy from the bending and releasing of fingers/elbows, speaking, walking, running and other human motions,^{[14-20]} the electric output is limited compared to batteries. In addition, during repeated stretching-releasing or long-term contact-separation, the resultant stress leads to detachment of tribolayer and electrode, reducing the device output.^{[21]} Hence, in addition to boosting the electric output, developing a material that can simultaneously function as the tribolayer and electrode is an effective approach to address the detachment issue.

Water polyurethane (WPU) is a representative positive tribolayer due to its abundant electron-donating functional groups. He et al.^{[22]} introduces Diels-Alder (DA) reaction groups into WPU segment and applies this material as the positive tribolayer to enhance the self-healing performance of the device. With fluorinated ethylene propylene (FEP) as counterpart in a 2×2 cm² TENG, the device attains an open circuit voltage (V_{OC}) of 58 V, a short circuit current (I_{SC}) of 3.2 μA, and a quantity of charge (Q_{SC}) of 17.6 nC. Bai et al.^{[23]} constructs a stretchable yarn-based TENG using a composite of WPU, poly(ethylene oxide) (PEO), and alliin, reaching a voltage of 137 V with a power density of 2.24 mW m⁻². Bai et al.^{[24]} prepares a current collector of PEO/WPU and phytic acid, and employs silicone rubber as the tribolayer in TENG, leading to an elongation at break of 318% and Q_{SC} of 34 nC. Yang et al.^{[25]} developed a composite electrode of carbon nanotubes (CNTs) and WPU for a paper-based TENG (8×8 cm²), delivering a V_{OC} of 67 V and I_{SC} of 3.7 μA. Jia et al.^{[26]} utilizes a WPU film and silicone rubber as positive and negative tribolayers, respectively, and assembles a single-electrode TENG with a contact area of 4×4 cm², delivering a Q_{SC} of 38.9 nC, V_{OC} of 114.7 V, and I_{SC} of 0.82 μA.

On the other hand, a conductive salt is a necessary for the stretchable ionic electrode. Bis(trifluoromethanesulfonyl)imide (TFSI) anion-based salt has a high degree of solubility and thermal stability and is widely utilized in solid electrolyte-based ionic conductors.^{[27]} With the fast development of kinetic energy harvesters, lithium bis(trifluoromethanesulfonyl)imide (LiTFSI) has recently been introduced in solid ionic conductor TENG,^{[28-37]} to prevent liquid evaporation and leakage. Li⁺ and TFSI⁻ disperse homogeneously in the solid conductor. Driven by an external electric field, Li⁺ de-coordinates and coordinates with different oxygen elements, leading to migration of cations in the ionic tunnel formed by ether groups.^{[38]} In addition, the electrostatic force and crosslinking of Li⁺ significantly improve stretchability.^{[39]} Zhang et al.^{[35]} reports an ionic electrolyte composed of LiTFSI and butyl acrylate as the monomer. The resulting device exhibits a high stretchability and stability in a wide temperature range. Zhang et al.^{[36]} develops 1-ethyl-3-methylimidazolium (EMIM)-TFSI and LiTFSI-based crosslinked network as electrode and obtains a maximum power density of 157.1 mW m⁻². Kim et al.^{[37]} fabricates a dual ionic liquid-based TENG, containing EMIM-TFSI and LiTFSI and illustrates high ionic concentration leading to the decrease of surface charge density. In brief, although LiTFSI is an excellent ionic conductor candidate in TENG, it negatively affects charge density due to charge leakage. Furthermore, fluorine has a strong electron-withdrawing property, which is not conducive to the overall tribopositivity of the material. To address these issues, surfactants are applied for tuning the interface characteristics of a liquid.^{[40]} During evaporation of a surfactant solution, the molecules assemble on the surface of the solution forming a film with the hydrophilic groups facing the solution and the hydrophobic groups facing the outside.^{[41,42]} To satisfy the demand toward high conductivity and electric output, some embodiments of the invention introduce a surfactant self-assembly approach to avoid the negative effect of F-containing ionic salt on the tribopositivity.

Some embodiments of the invention develop a solid ionic conductive material with high relative permittivity, which acts as both the tribolayer and electrode simultaneously, preventing the detachment of tribolayer and electrode. The novel highly conductive and tribopositive material fabricated by the assistance of self-assembled sodium dodecyl benzene sulfonate (SDBS) is employed during the process of solvent evaporation of LiTFSI and WPU emulsion. SDBS uniformly covers the surface of LiTFSI and WPU-based, effectively improving its tribopositivity by preventing an excessive amount of exposed LiTFSI forming on the surface. This work investigates the impact of SDBS and LiTFSI on the surface concentration of Na⁺ ions, and hypothesizes that the Li⁺ ions displace the Na⁺ ions. In this regard, SDBS provides additional free-moving Na⁺ ions, thereby adjusting the surface elemental distribution. In addition, Li⁺ ions provide an electrostatic force between SDBS and the —NH— group of WPU. Besides, the LiTFSI/SDBS/WPU-based TENG renders a high ionic conductivity with Qsc being 2-fold and 4-fold higher than that of WPU-based TENG and LiTFSI-based TENG, respectively. The device is used to harvest the kinetic energy from human motions, such as fingers bending and releasing and walking, effectively powering LEDs, capacitors, and electronics. The device with a dimension of 5 cm×5 cm generates V_{OC} and I_{SC} of 260 V and 22 μA, respectively. The embodiments of the invention provide a simple yet effective surface modification strategy through surfactant self-assembly for use in motion sensing and energy harvesting.

### 2. Results and Discussion

### 2.1. Material Properties

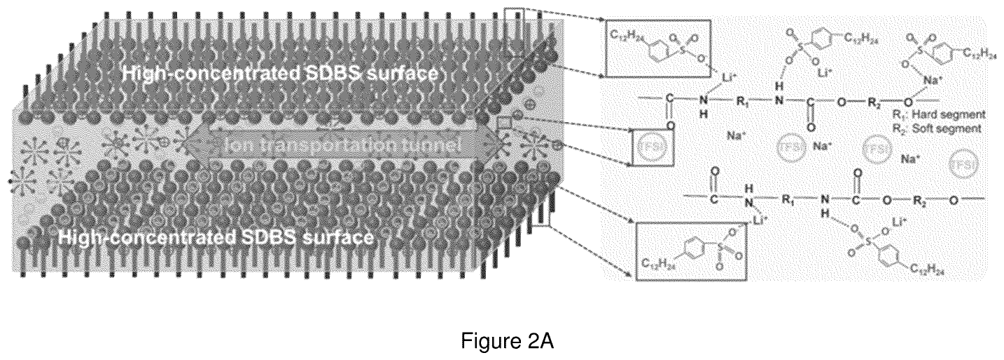

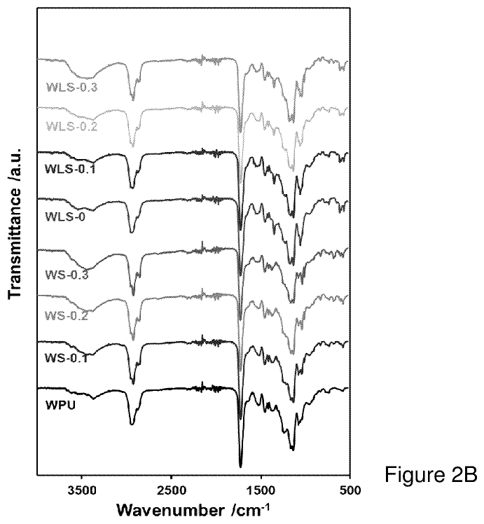

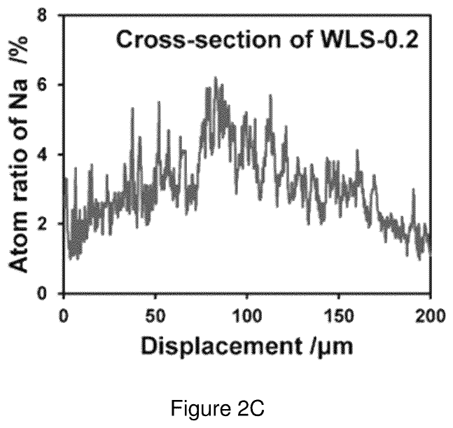

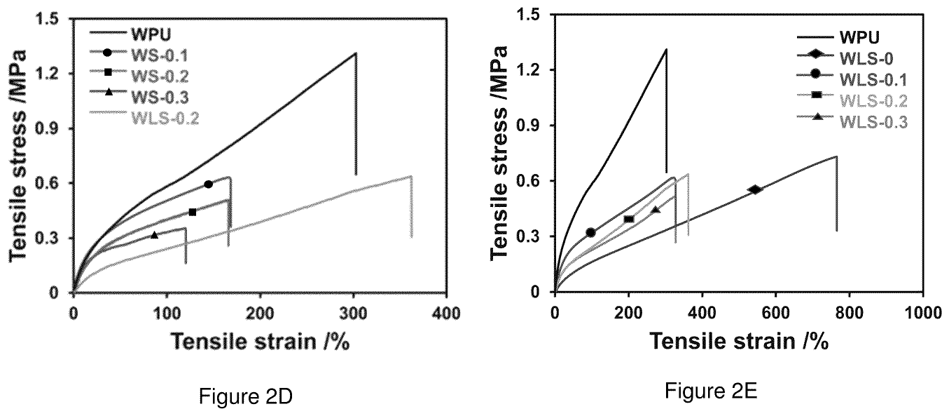

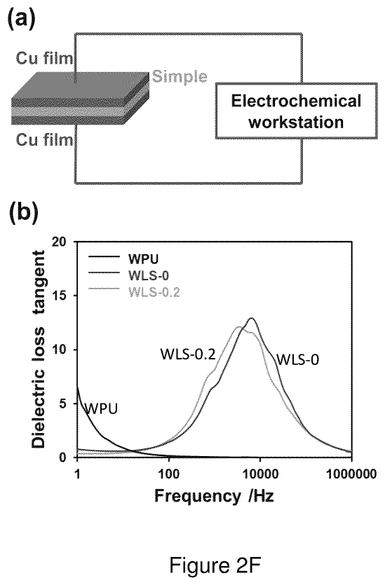

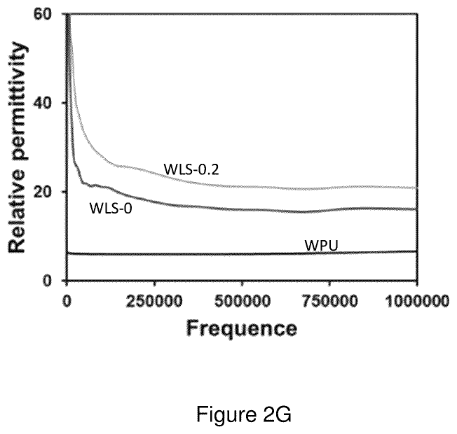

SDBS is an amphoteric surfactant, with a tendency to assemble in an orderly manner on the surface as the solvent evaporates.^{[43]} As shown in FIG. 2A, the hydrophobic groups aggregate toward the surface while the hydrophilic terminals aggregate toward the inner side of the film. In the mixture of LiTFSI, SDBS, and WPU, Li⁺ ions displace Na⁺ ions, forming a stronger electrostatic force between Li⁺ and SDBS. In addition, Li⁺ ions are attracted by the isolated electrons of amino group (—NH—) in WPU. Therefore, SDBS is crosslinked with WPU via electrostatic and hydrogen bonding. 1 g WPU doped with 0.1 g, 0.2 g and 0.3 g SDBS are labeled WS-0.1, WS-0.2, and WS-0.3, respectively. 0.1 g LiTFSI mixed with 1 g WS-0.1, 1 g WS-0.2, and 1 g WS-0.3 are labeled WLS-0.1, WLS-0.2, and WLS-0.3, respectively. As shown in FIG. 2B, the fourier transform infrared spectrometer (FTIR) spectra reveal the functional groups of WPU. The peak at 3300 to 3500 cm⁻¹ corresponds to the N—H bending, while the peak from 2800 to 3000 cm⁻¹ corresponds to the asymmetric and symmetric stretching of C—H. In addition, the peaks at 1731 and 1650 cm⁻¹ correspond to the stretching of C═O and hydrogen-bonded amide.^{[44]}

Compared to the flat WPU film, WS-0.2 exhibits small bulges of several microns due to the aggregation of SDBS. On the other hand, all WLS-0.1, WLS-0.2, and WLS-0.3 films show flat surfaces, indicating an even dispersion of SDBS on the surface of the films due to the presence of LiTFSI. Furthermore, Na and S elements are uniformly distributed, meaning that SDBS is homogeneously dispersed throughout the WS-0.2 film. Also, Na, S, and F elements are uniformly distributed. The atom ratio of Na in the cross-section of WLS-0.2 is provided in FIG. 2C, showing a thickness of ˜200 μm. As shown in FIG. 2C, the scanning direction is from the top surface to the bottom surface, showing the Na distribution from the surface to the bulk of WLS-0.2. The result shows that the Na ratio increases from the surface to the bulk, indicating that more Na⁺ ions are distributed to the bulk of the film. This phenomenon is a result of some Li⁺ ions displacing the Na⁺ ions of SDBS leading to lower surface concentration of Na. Salts and additives influence the crosslinking and thus the mechanical abilities of the films. WPU has good stretchability with an elongation at break of 303% and a tensile stress of 1.3 MPa. However, SDBS decreases the stretchability as it breaks the crosslinking of the WPU chains. On the other hand, LiTFSI increases stretchability leading to an elongation at break of 765%, which is 2.5-fold higher than WPU. The modulus of WLS-0.2 is lower than that of WS-0.2 as LiTFSI acts as plasticizer decreasing the elastic modulus. The function of Li⁺ and TFSI⁻ plasticizers is to break the bonds between two adjacent WPU molecules and form new bonds with WPU chains, thereby increasing the stretchability and reducing the tensile stress. In detail, —CF₃ and —S═O form hydrogen bonds with —CH₂/—NH in WPU and Li⁺ forms bonds with —C═O in WPU.^{[28]} At the same time, the rigid hydrogen bonds between WPU chains are broken. Further, the elongation at break of WLS-0.2 also remains higher than WPU. Additionally, at 300% elongation, the tensile stress of WLS-0.2 is 0.56 MPa, which is 1.7-fold higher WLS-0 (FIG. 2D, FIG. 2E) due to the presence of SDBS. The content of ions and surfactant in the conductive solid material also influences the relative permittivity by the change of material's endurable capacity according to Equation (1-4).^{[45]}

$${ε}_{r} = \frac{ε}{{ε}_{0}} = \frac{{C}_{c}}{{C}_{0}} \qquad ( 1 )$$

$${ε}_{r} = \frac{{z}^{″}}{ω {C}_{0} ( {z}^{′2} + {z}^{″2} )} \qquad ( 2 )$$

$${ε}^{″} = \frac{{z}^{′}}{ω {C}_{0} ( {z}^{′2} + {z}^{″2} )} \qquad ( 3 )$$

$$tan δ = \frac{{ε}^{″}}{{ε}_{r}} \qquad ( 4 )$$

where εᵣ is relative permittivity, ε is permittivity, ε₀ is vacuum permittivity, Cₓ is the capacity of a plate capacitor with the tested material as the dielectric, and C₀ is the capacity of a plate capacitor with air or vacuum as the dielectric. C₀=e₀/k, where e₀ is the permittivity of free space (8.854×10⁻¹² F m⁻¹). k=I/A, where I is the thickness, A is the area of the sample and ω is the angular frequency 2πf. ε″ represents the ionic conduction component, and tan δ is the dielectric loss tangent. As shown in FIG. 2F and FIG. 2G, the relative permittivity of WLS-0.2 reaches 22, which is 1.4-fold higher than WLS-0 and 3.7-fold higher than WPU. The dielectric loss of WLS-0 and WLS-0.2 at low frequency (<50 Hz) is lower than 1. However, in the frequency range of 100 to 100 000 Hz, the dielectric loss is considerably higher owing to the incorporation of LiTFSI. Li⁺ and TFSI⁻ in the polymeric chains, thereby increasing the ionic conductivity and dielectric loss. During ion transport, some of the kinetic energy is converted to thermal energy.

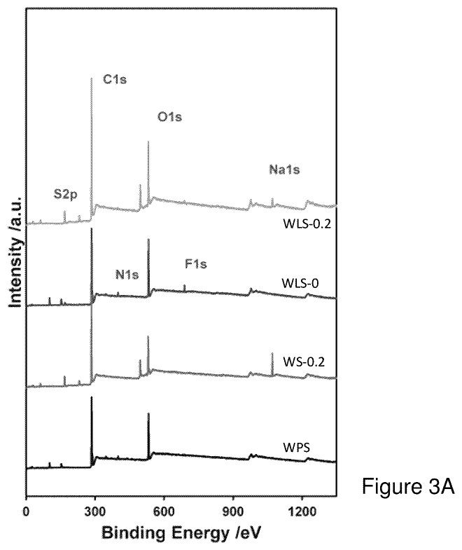

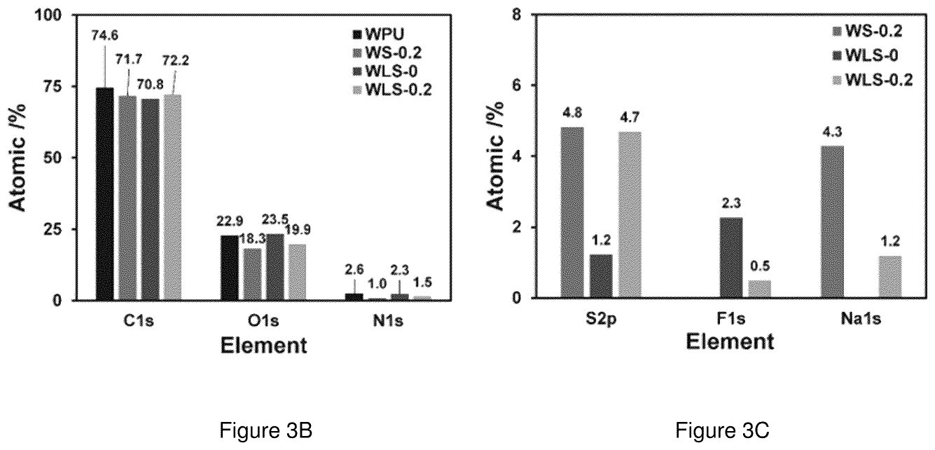

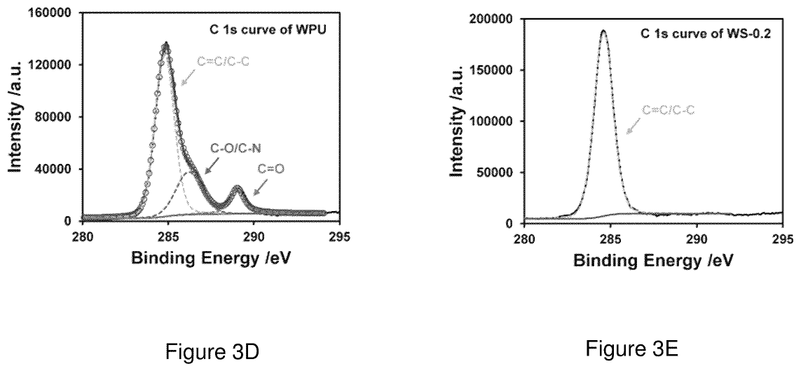

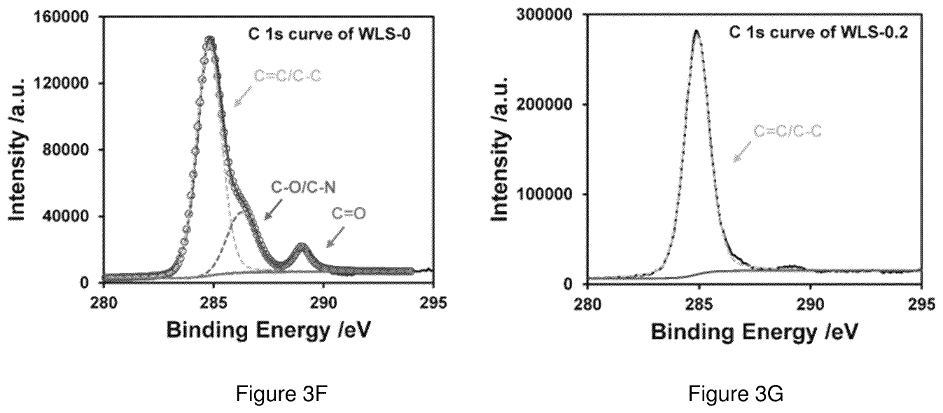

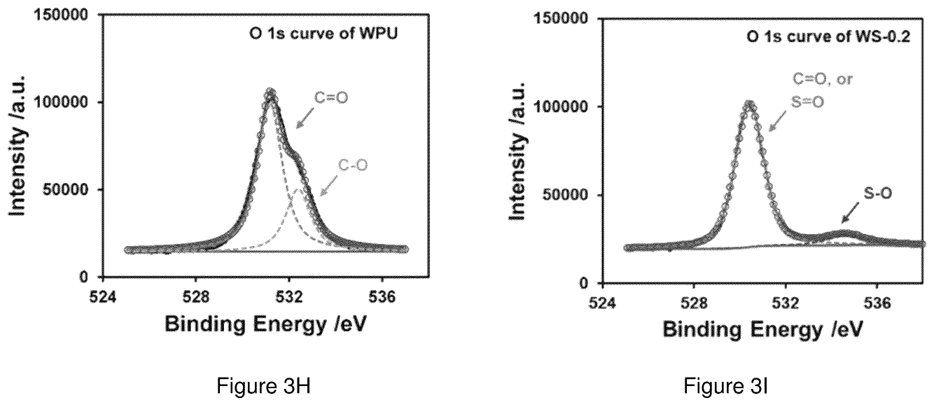

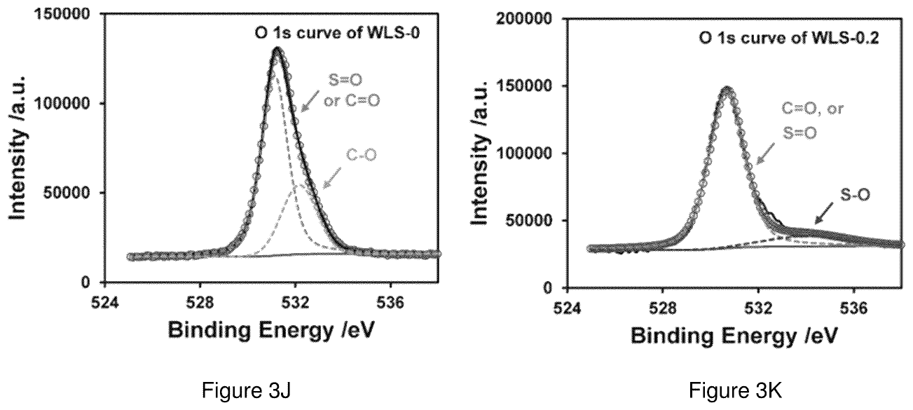

The impact of SDBS on the surface chemical properties is studied by X-ray photoelectron spectroscopy (XPS). As shown in FIGS. 3A-3C, in contrast to WPU, WS-0.2 and WLS-0.2 exhibit peaks corresponding to Na (1067-1074 eV) and S (165-171 eV). While Na accounts for 4.3% and 1.2% of the surface composition of the WS-0.2 and WLS-0.2 films, respectively, S accounts for 4.8% and 4.7% of the WS-0.2 and WLS-0.2 films, respectively. In the XPS of WLS-0, a peak corresponding to F atoms (684-692 eV) accounting for 2.3% of the surface can also be observed. Since Na is derived from SDBS, and F from TFSI⁻, these spectra indicate that SDBS is successfully dispersed on the surface of WS-0.2 and WLS-0.2, and that TFSI⁻ exists on the surface of WLS-0. However, compared to the peak of WLS-0, WLS-0.2 has a smaller peak corresponding to F. The percentage of F on the surface also decreased from 2.3% to 0.5%, indicating that SDBS dominates the surface, effectively reducing the surface F content. The spectra of C1 s and 01 s peaks also clearly show the different surface functional groups as shown in FIGS. 3D-3K. Three C species exist on the surface of WPU and WS-0.2, as indicated by the peaks at 284.8, 286.4, and 289.2 eV, corresponding to the functional groups of C═C/C—C, C—O/C—N and C═O^{[46]} (FIG. 3D, FIG. 3F). On the other hand, the characteristic peak of WS-0.2 and WLS-0.2 occurs at a binding energy of 284.8 eV, indicating the presence of only C═C/C—C functional groups (FIG. 3E, FIG. 3G). Similarly, the S—O (534.9 eV) exists in WS-0.2 and WLS-0.2^{[47,48]}, indicating that SDBS covers the surface, reducing the content of TFSI-on the surface (FIG. 3C, FIG. 3I, FIG. 3K).

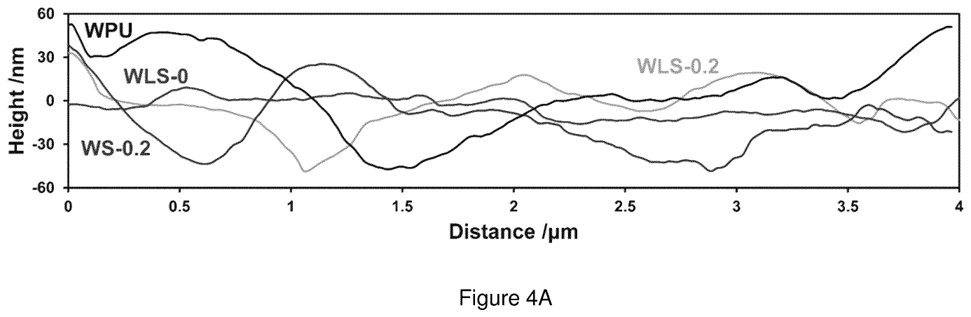

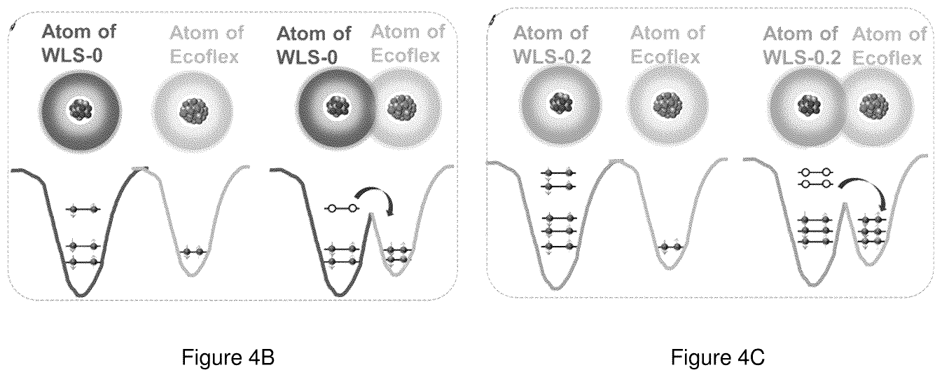

To assess the charge affinity, the change of surface potential caused by LiTFSI and SDBS is studied by kelvin probe force microscopy (KPFM). As shown in FIG. 4A, the surface topography maps and relative height line indicate low roughness of WPU (Ra: 24.6 nm), WS-0.2 (Ra: 22.1 nm), WLS-0 (Ra: 7.1 nm), and WLS-0.2 (Ra:21.4 nm). In addition, the surface potential of WPU, WS-0.2, WLS-0, and WLS-0.2 reaches 475, 638, 261, and 678 mV, respectively, indicating that the surface potential significantly increases with SDBS content, and that more electrons are transferred from WS-0.2 and WLS-0.2 in comparison to WPU and WLS-0. While LiTFSI reduces the surface potential, SDBS eliminates the negative impact of LiTFSI and increases the surface potential to a higher level. The charge transfer mechanism is illustrated by an electron-cloud-potential-well model (FIG. 4B, FIG. 4C).^{[49]} An atom can be regarded as a potential well with loose external surface electrons. Before two materials come into contact, electrons are trapped in the potential well. Upon contact, the electron cloud overlaps and the single-potential well becomes a double-potential well, which allows electrons to transfer from WLS-0/WLS-0.2 to Ecoflex. When the tribolayers separate, the transferred electrons are retained on the Ecoflex due to its energy barrier. Since WLS-0.2 is more tribopositive than WLS-0, more electrons transfer from WLS-0.2 to Ecoflex upon contact.

### 2.2. Electric Output

According to Equation (5), Higher Triboelectric Charge Density and Relative Permittivity Lead to Higher Inducted Charge Density.^{[50]}

$${σ}^{′} = \frac{σ {d}^{′}}{{d}_{1} / {ε}_{1} + {d}^{′} + {d}_{2} / {ε}_{2}} \qquad ( 5 )$$

where σ′ is the inducted charge density, σ is the triboelectric charge density, d′ is the gap distance, d₁ and d₂ are the thickness of the positive and negative tribolayers, respectively, while ε₁ and ε₂ represent the relative permittivity. Compared with other samples, WLS-0.2 has the highest relative permittivity and triboelectric charge density, indicating the highest inducted charge density.

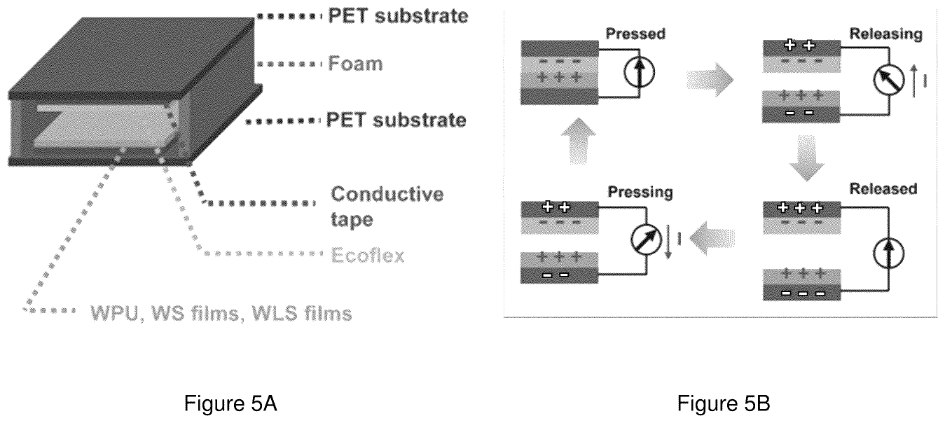

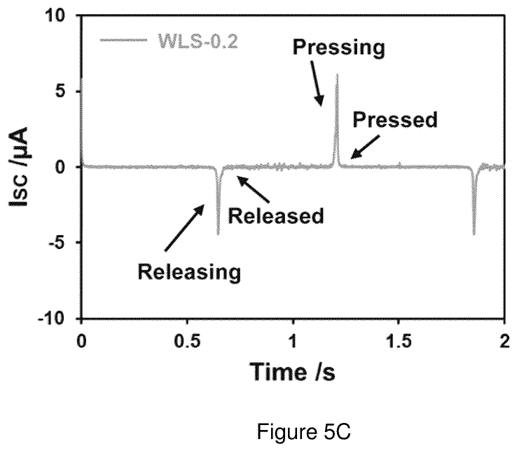

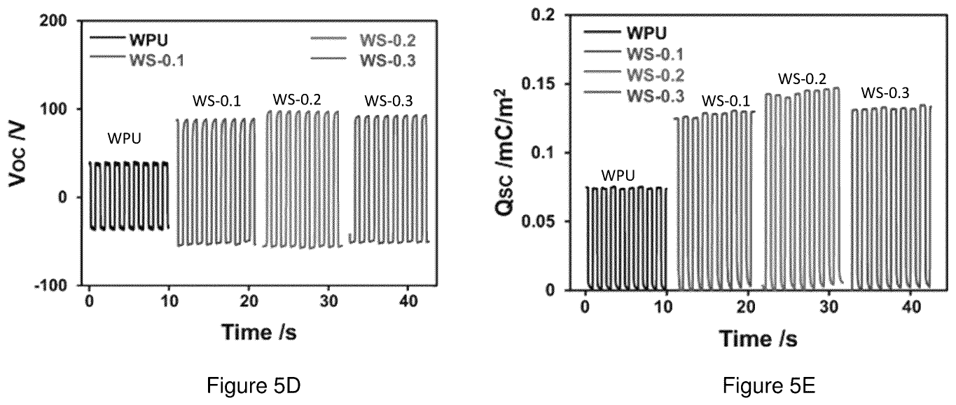

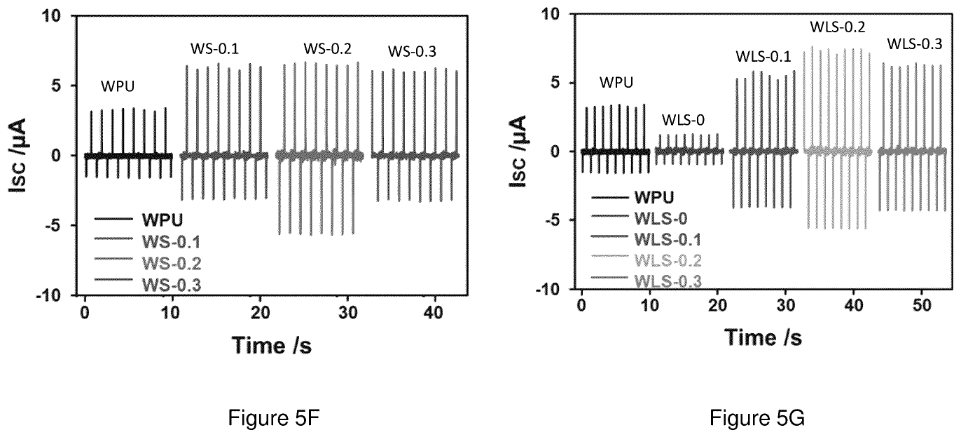

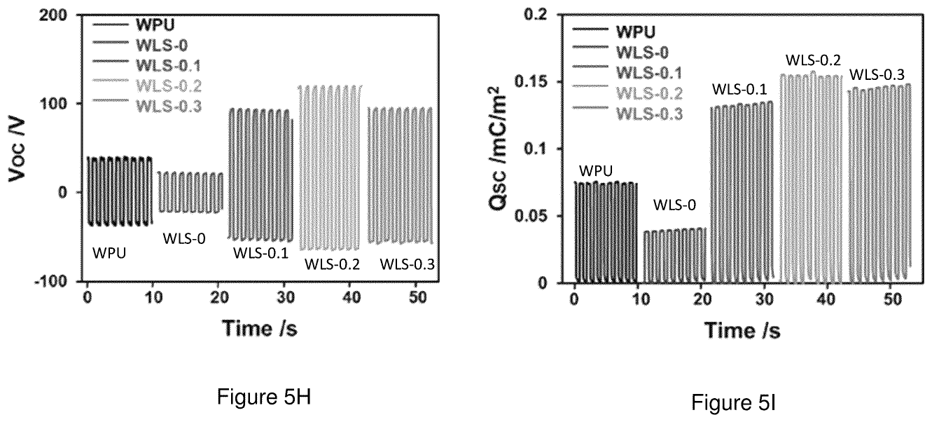

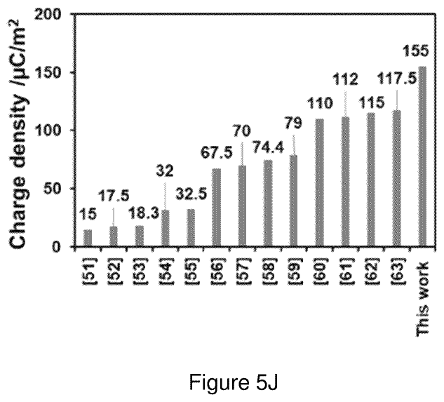

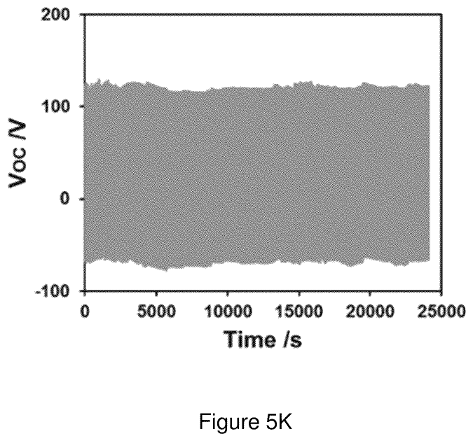

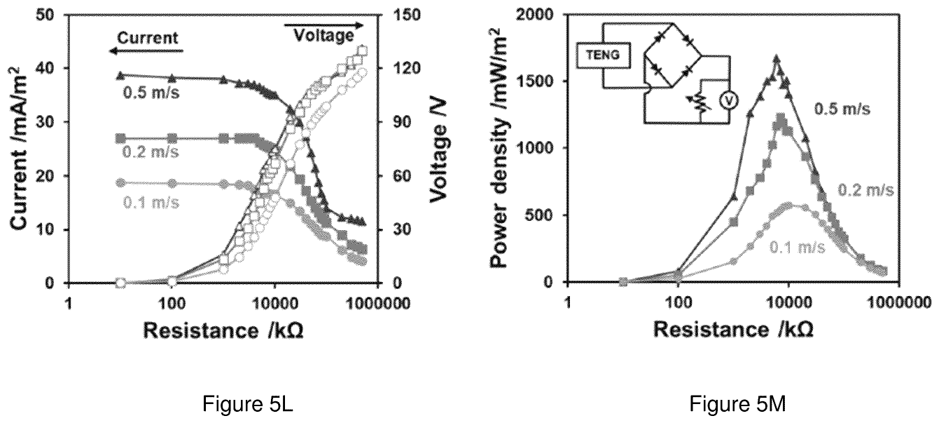

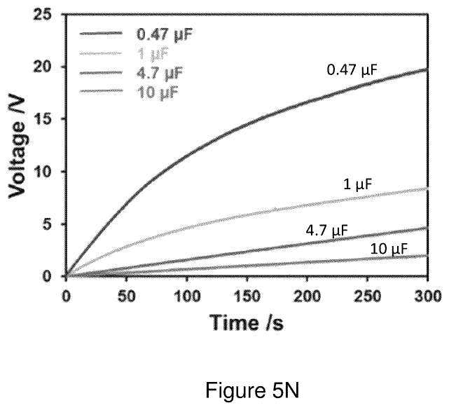

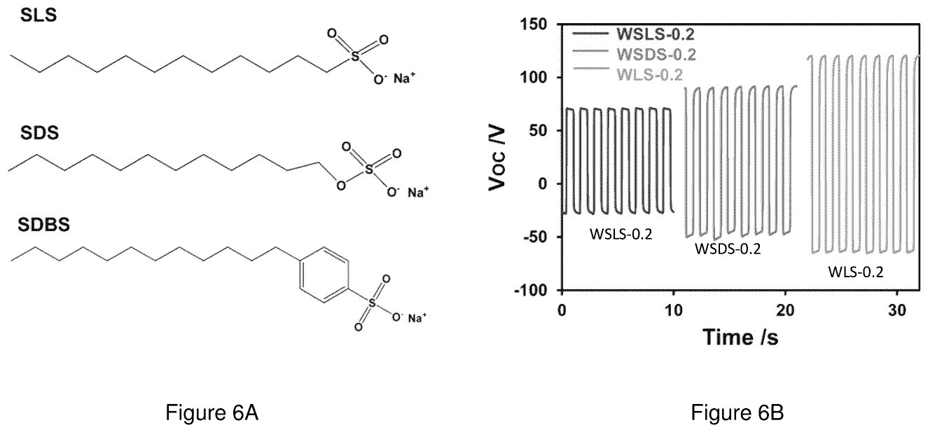

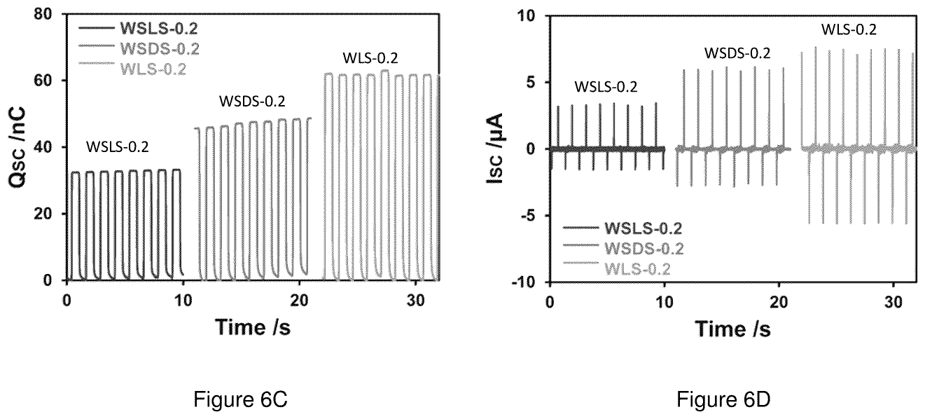

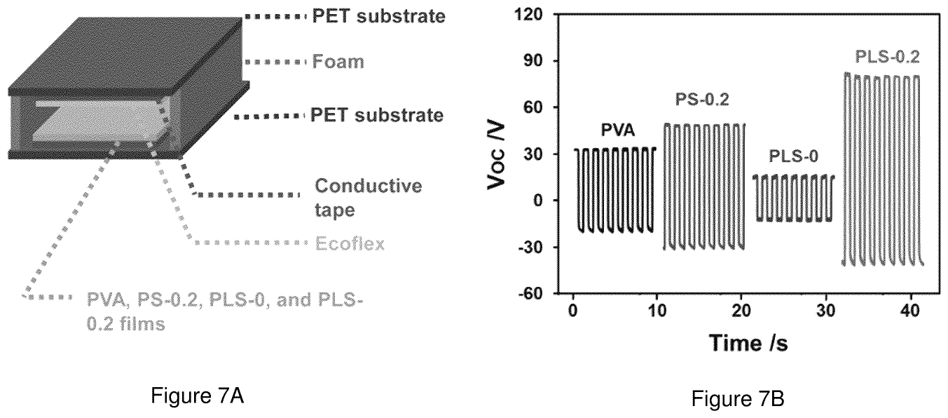

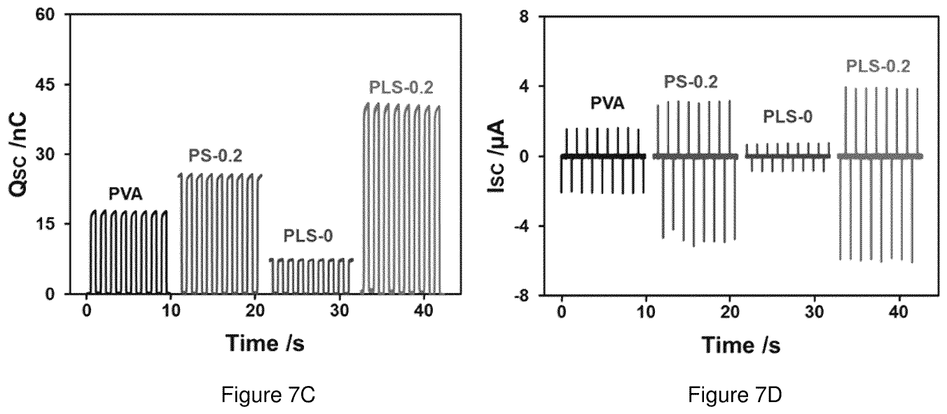

As shown in FIG. 5A, the designed films are utilized as the positive tribolayer, Ecoflex as the negative tribolayer, and conductive tape as the electrode. The fabricated TENG is taped on the linear motor probe with a gap distance of 5 mm between the tribolayers at a working speed of 0.1 m s⁻¹. When the films and Ecoflex come into contact, electrons are transferred from the film to Ecoflex. Upon separation, with increasing gap distance, opposite charges are inducted on the electrode. Conversely, the quantity of inducted charges on the electrode decreases with the decrease in gap distance (FIG. 5B), leading to generation of transient current during releasing or pressing (FIG. 5C). As shown in FIGS. 5D, 5E and 5F, compared to WPU-based TENG (with a V_{OC} of 40 V and Q_{SC} of 0.075 mC m⁻²), WS-0.1, WS-0.2, and WS-0.3 have higher electric output, rendering a V_{OC} of 88, 98, 92 V, and Q_{SC} of 0.128, 0.145, 0.135 mC m⁻², respectively. In particular, the electric output of WS-0.2 is about 2-fold higher than WPU-based TENG. However, compared with WPU-based TENG, WLS-0 reduced the output by half with V_{OC} and Q_{SC} of 22 V and 0.038 mC m⁻². Although LiTFSI adversely affected the output, SDBS significantly increased the output compared to WS-0.2. WLS-0.2 exhibited V_{OC} and Q_{SC} of 120 V and 0.155 mC m⁻², respectively (FIGS. 5C-5I). The self-assembled SDBS avoids the adverse impact of LiTFSI, leading to the enhanced electric output. Besides, the approach is extended to other surfactants and materials (FIGS. 6A-6D, 7A-7D) indicating universality of the self-assembled surfactant strategy. According to FIGS. 6A-6D, the impact of surfactant on electric output is investigated. Compared with WPU-based and WLS-0-based devices, WSLS-0.2-based and WSDS-0.2-based TENGs have higher electric outputs. In particular, WLS-0.2-based TENG exhibits the highest electric output. According to FIGS. 7A-7D, the impact of the polymeric material on electric output is investigated. The electric output of PS-0.2 (0.2 g SDBS in 1 g PVA) and PLS-0.2 (0.2 SDBS in 1 g PVA and 0.1 g LiTFSI) is 1.7-fold and 2.7-fold higher than that of PVA-based TENG, showing that the approach can be adopted to other materials.

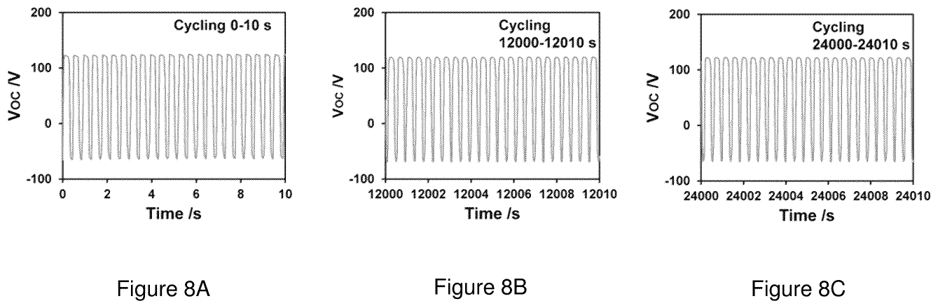

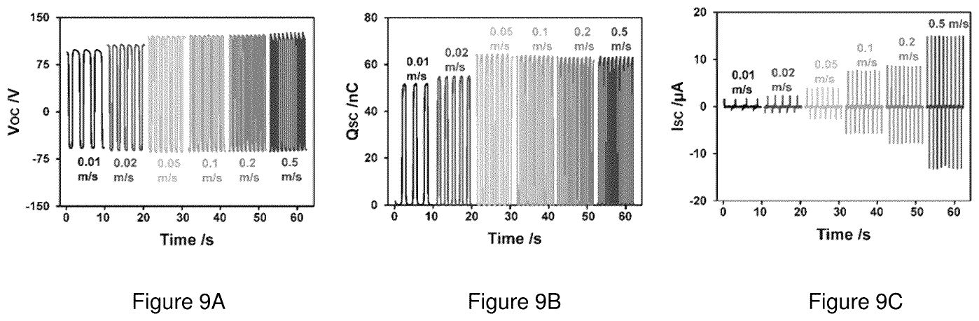

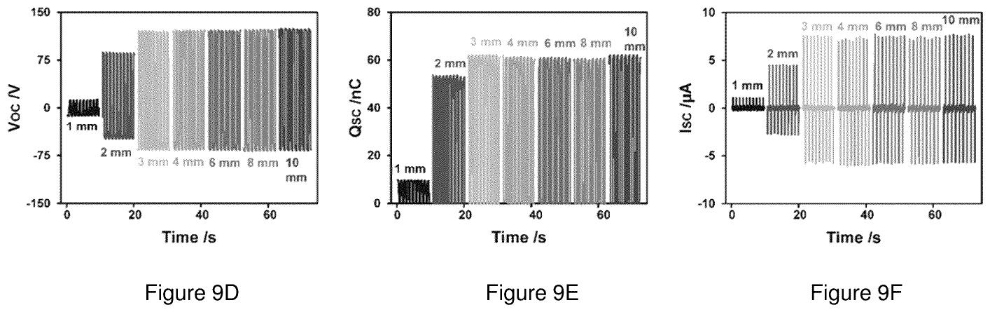

With its high electric output, the WLS-0.2-based TENG is able to lit up 242 LEDs connected in series with a charge density of 155 μC m⁻², which is higher than reported WPU-based and other related TENGs (FIG. 5J).^{[51-63]} The device also exhibits excellent stability, retaining 100% of its V_{OC} after 50000 cycles. (FIG. 5K, FIGS. 8A-8C). The impacts of working speed and gap distance between tribolayers are shown in FIGS. 9A-9F. V_{OC} and Q_{SC} increased with increasing working speed from 0.01 to 0.05 m s⁻¹ and remained constant when the speed was further increased from 0.05 to 0.5 m s⁻¹. On the other hand, I_{SC} continuously increased with increasing working speed as current is inversely proportional to the time taken by electrons to travel through the external circuit. According to Equation (5), the inducted charge density is correlated with the gap distance (d′). Given the selected material, d₁/ε₁+d₂/ε₂ can be regarded as a constant r. Thus, Equation (5) can be expressed as

$${σ}^{′} = \frac{σ {d}^{′}}{r + {d}^{′}} . \qquad ( 6 )$$

Therefore, if d′>>r, σ′≈σ. As shown in FIGS. 9D-9F, since gap distance influences the quantity of inducted charges on the electrode, the electric output increases significantly when the gap distance increases from 1 to 3 mm. However, the electric output remains constant when the gap distance is further increased above 3 mm, indicating that 3 mm represents the optimal gap distance toward charge induction. Three working speeds are adopted to investigate the power density at different load resistances. With increasing resistance, the current decreases and the voltage increases (FIG. 5L).

$$Power density = \frac{{V}^{2}}{R \cdot Area} \qquad ( 7 )$$

where R and V represent the load resistance and corresponding voltage, respectively, and Area corresponds to the contact area. Using Equation (7), the power density of WLS-0.2-based TENG is 574 mW m⁻² at 10 MΩ, 1231 mW m⁻² at 7 MΩ, and 1675 mW m⁻² at 6 MΩ at working speed of 0.1, 0.2, and 0.5 m s⁻¹, respectively (FIG. 5M). Due to the high electric output and power density, this device with working speed of 0.1 m s⁻¹ is applied to charge 0.47, 1, 4.7, and 10 μF capacitors to 19.7, 8.4, 4.7, and 2.0 V within 300 s (FIG. 5N).

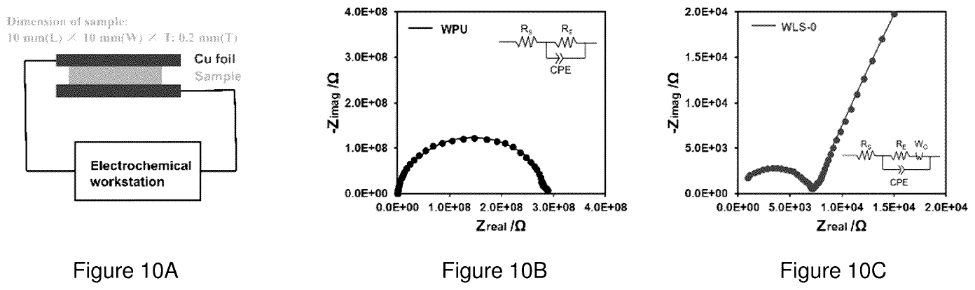

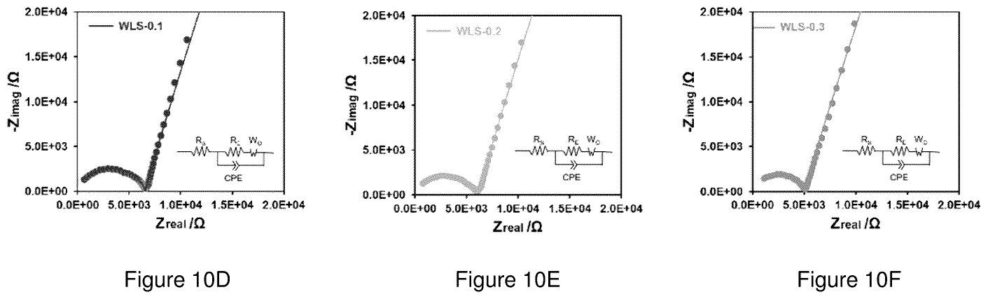

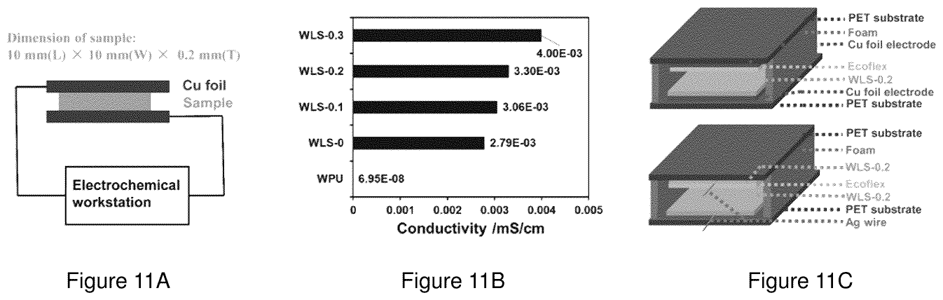

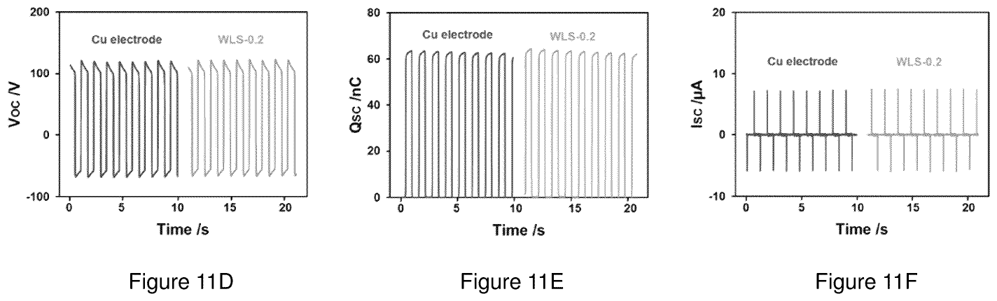

The presence of the free-moving Na⁺ and TFSI⁻ ions in the modified WPU films leads to ionic conductivity. As shown in FIGS. 10A-10F and FIG. 11A, the films with the dimension of 10 mm×10 mm×0.2 mm are inserted into two pieces of Cu foils and connected to an electrochemical workstation to conduct electrochemical impedance spectroscopy (EIS). The ionic conductivity of the films can be calculated according to Equation (8).

$$= \frac{L}{RA} \qquad ( 8 )$$

where 6 represents ionic conductivity; L, R, and A are the thickness, resistance, and dimension of the film, respectively.

The WPU film shows limited ionic conductivity due to the lack of free-moving ions (6.98×10⁻⁸ mS cm⁻¹). Since Na⁺ is freed and displaced by Li⁺, WLS-0.3, WLS-0.2, and WLS-0.1 exhibits higher ionic conductivity (4.00×10⁻³, 3.30×10⁻³, and 3.06×10⁻³ mS cm⁻¹, respectively) than WLS-0 (FIG. 11B). To investigate the impact of ionic conductivity on the electric output, two TENGs are fabricated employing two different electrodes as shown in FIG. 11C. Both devices use WLS-0.2 as the positive tribolayer and Ecoflex as the negative tribolayer. The reference TENG uses Cu foil electrode as the electrode, while the other adopts WLS-0.2 as the electrode. Although different electrodes are used, the electric output is similar as shown in FIGS. 11D-11F, indicating that WLS-0.2 can act as an electrode with equivalent performance to metal electrode.

### 2.3. Energy Harvesting and Monitoring of Human Body Motions

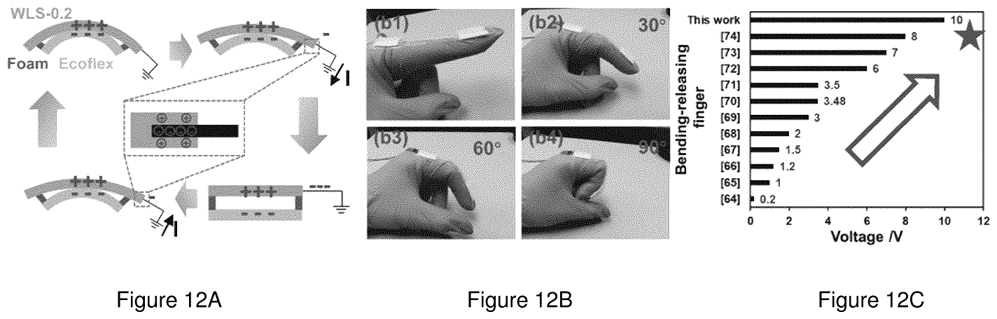

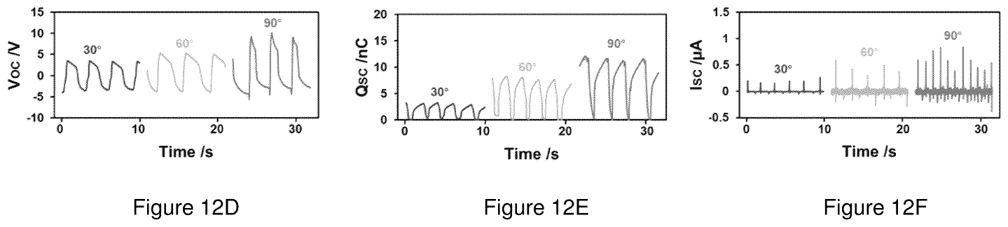

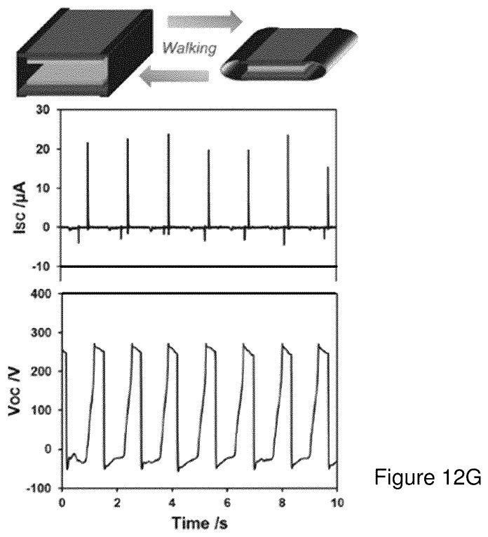

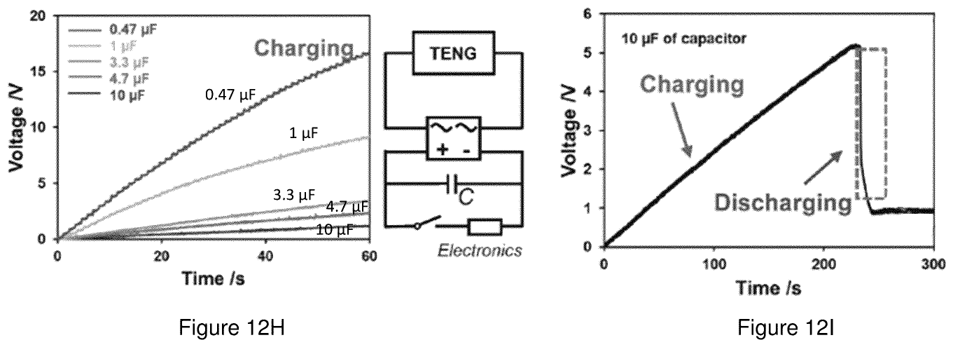

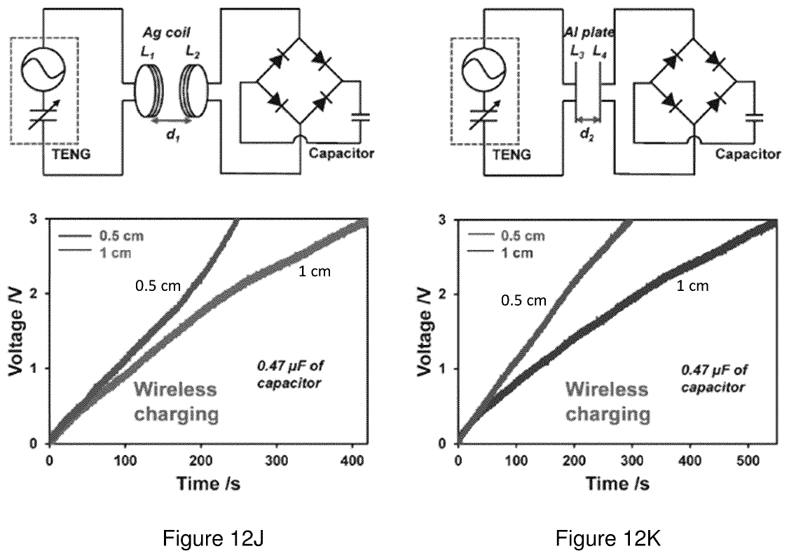

The stretchable ionic conductive WLS-0.2 can simultaneously act as the positive tribolayer and electrode. As shown in FIG. 12A, the positive tribolayer and electrode of WLS-0.2 and the negative tribolayer of Ecoflex are used to fabricate a single-electrode TENG with a gap distance of 3 mm. When the finger is bent, WLS-0.2 contacts Ecoflex, and electrons are transferred from WLS-0.2 to Ecoflex. On the other hand, when the finger is released, with the decrease of contact area, opposite charges are inducted on the metal wire side and electric double layers are formed on the interface. As shown in FIG. 12B, the device output is investigated at bending degrees of 30°, 60°, and 90°. With increasing bending degree from 30° to 90°, V_{OC} increases from 3.5 to 10 V, which is significantly higher compared to prior works (FIG. 12C),^{[64-74]} while Q_{SC} and I_{SC} increase from 3.1 to 11.3 nC and 0.2 to 0.7 μA, respectively (FIGS. 12D-12F).

A 5×5 cm² two-electrode device is fabricated and mounted on a shoe sole as shown in FIG. 12G. The V_{OC} and I_{SC} reach 260 V and 22 μA, lighting up LEDs of the word ‘CityU’ placed on the side of the shoe while walking. This device successfully charges the 0.47, 1, 3.3, 4.7, and 10 μF capacitors for 60 s to 16.8, 9.3, 3.4, 2.3, and 1.2 V, respectively, as shown in FIG. 12H. According to Equation (9), the energy stored in these capacitors are 66.3, 43.2, 19.1, 12.4, and 7.2 μJ, respectively.

$$E = \frac{1}{2} {C V}^{2} \qquad ( 9 )$$

where E is energy stored in the capacitor, while C and V are capacitance of the capacitor and voltage of the capacitor. In particular, the 10 μF capacitor is charged to 5 V within 220 s and is used to power a stopwatch as shown in FIG. 12I. The stopwatch is powered for over 9 s as the voltage of the capacitor reduces from 5 to 1 V.

The device is also used in wireless transmission technology. Ag coils with an external diameter of 7 cm and inner diameter of 6 cm, and Al plates (5×5 cm²) with a distance between plates of 0.5 cm and 1 cm are selected to transmit and receive the output signals. As shown in FIGS. 12J and 12K, the two-electrode TENG successfully charges a 0.47 μF capacitor using the wireless circuit. In addition, the Ag coil circuit shows improved charging efficiency in comparison to Al plates circuit due to electromagnetic induction.

3. Conclusion According to the embodiments of the invention, a novel strategy is developed for enhancing the tribopositivity of ionic conductive WPU. Through surfactant self-assembly during film formation, SDBS uniformly covers the surface of WPU/LiTFSI, thus avoiding charge leakage and consumption caused by LiTFSI. The V_{OC}, Q_{SC}, and I_{SC} reach 120 V, 62 nC, and 7.5 μA at working speed of 0.1 m s⁻¹, while the power density reaches 1675, 1231, and 574 mW m⁻² at 0.5, 0.2, and 0.1 m s⁻¹, respectively, which represent the highest output among WPU-based TENGs. In addition, the effects of doped surfactant on the mechanical properties and ionic conductivity are investigated. Through displacement of Na⁺ by Li⁺, the crosslinking between SDBS and WPU is enhanced, and thus additional free moving Na⁺ ions facilitate the movement of ions in an induced electric field. Benefitting from high electric output, stretchability (362% elongation at break) and ionic conductivity (3.30×10⁻³ mS cm⁻¹), the modified WPU acts as positive tribolayer and electrode simultaneously. Moreover, the fabricated device employing WLS-0.2 effectively monitors and harvests the kinetic energy of human body motion. These embodiments of the invention not only pave the way toward a novel design concept of high-performance solid ionic-conductive-based devices, but also extend their application to wearable electronics.

### 4. Experimental Methods

Water polyurethane (WPU, solid content: 60 wt. %), sodium dodecyl benzene sulfonate (SDBS, purity: 98%), sodium lauryl sulfonate (SLS, purity: 98%), and sodium dodecyl sulfate (SDS, purity: 98%) were purchased from Shanghai Maikelin Biochemical Technology Co Ltd; Lithium bis(trifluoromethanesulfonyl)imide (LiTFSI, purity: 99%) and Ecoflex 0050 were purchased from Sigma-Aldrich and Smooth-On Incorporated, respectively. The polyethylene terephthalate (PET) substrate (thickness of 0.2 mm) was purchased from Kunshan Kaizhu Composite Materials Co Ltd. Fluorinated ethylene propylene (FEP), polytetrafluoroethylene (PTFE), and polyimide (PI) were purchased from Jincheng Plastic Co Ltd. The resistivity of DI water is 18 MΩ cm⁻¹.

### 4.1. Preparation of WPU, WS, and WLS Films

10 g of WPU was added into 110 g of distilled water and stirred homogeneously to form an emulsion (Solid content: 5 wt. %) labeled 5 wt. % WPU. Next, 20 g of 5 wt. % WPU was poured into a cultural dish with a diameter of 9 mm and was placed on a hotplate at 60° C. After 12 h, a film was formed and labeled as WPU.

1 g of SDBS was dissolved into 9 g of distilled water and labeled as 10 wt. % SDBS. 1 g, 2 g and 3 g of 10 wt. % SDBS were each added into 20 g of 5 wt. % WPU, stirred for 0.5 h and named as WS-0.1 emulsion, WS-0.2 emulsion and WS-0.3 emulsion, respectively. Next, the above mixtures were poured into three cultural dishes and placed on a hotplate at 60° C. After heating for 12 h, three films were formed and labeled WS-0.1, WS-0.2, and WS-0.3, respectively.

1 g of LiTFSI was added into 9 g of distilled water and stirred for 0.5 h to get 10 wt. % LiTFSI solution. Additionally, 1 g of 10 wt. % LiTFSI solution was added into 20 g of 5 wt. % WPU, WS-0.1, WS-0.2 and WS-0.3 emulsions, respectively, and stirred homogeneously. The above mixtures were then poured into four cultural dishes of diameter 9 cm and heated at 60° C. for 12 h to form four films labeled WLS-0, WLS-0.1, WLS-0.2 and WLS-0.3, respectively.

### 4.2. Preparation of WSLS-0.2 and WSDS-0.2

1 g of SLS was dissolved in 9 g of distilled water and named as 10 wt. % SLS. Next, 2 g of 10 wt. % SLS and 1 g of 10 wt. % LiTFSI were mixed in 20 g of 5 wt. % WPU and stirred for 0.5 h. The mixture was poured into a cultural dish and placed on a heating panel at 60° C. for 12 h to form a film labeled WSLS-0.2. The same procedure was repeated using SDS instead of SLS, and the resultant film was labeled WSDS-0.2.

### 4.3. Fabrication of TENG

### 4.3.1. Fabrication of PET-Supported TENG

The double-sided conductive tape, the negative tribolayers of Ecoflex, FEP, PTFE, PI, and PET, the positive tribolayers of WPU, WS-0.1, WS-0.2, WS-0.3, WLS-0, WLS-0.1, WLS-0.2, WLS-0.3, WSLS-0.2, and WSDS-0.2 were cut to a dimension of 2×2 cm² and PET plate as the substrate was cut to 3×3 cm². For the positive patch, the conductive tape linked to an extended conductive electrode was mounted on the PET substrate. Next, the positive tribolayer was fixed on the other side of conductive tape. Similarly, for the negative patch, Ecoflex was fixed on a conductive tape-PET. Two pieces of foams were attached on the PET films and used to separate the positive and the negative patches.

### 4.3.2. Fabrication of Single-Electrode TENG

WLS-0.2 and Ecoflex were cut to a dimension of 1×5 cm². Two pieces of 3 mm adhesive foams were inserted into two terminals of WLS-0.2 and Ecoflex. This TENG was then taped onto a nitrile glove to test the bending angle of the index finger.

### 4.3.3. Fabrication of Two-Electrode TENG

The double-sided conductive tape, Ecoflex, and WLS-0.2 were cut to a dimension of 5×5 cm² while the PET plate as the substrate was cut to the dimension of 6×6 cm². The positive tribolayer of WLS-0.2 and the negative tribolayer of Ecoflex were sticked onto two pieces of PET substrate using the double-sided conductive tape. Finally, two pieces of Kapton were adhered to link the negative patch and the positive patch with a gap distance of 10 mm.

### 4.4. Characterization

Surface morphology and element distribution images were obtained using a scanning electron microscope with energy dispersive spectroscope (Thermo Scientific Helios 5 CX). Chemical functional groups were tested using Fourier transform infrared spectrometer (Nicolet iS50 FT-IR). Mechanical properties were studied using mechanical tester (Instron 34SC-05). Surface roughness and surface potential were measured using atomic force microscopy and kelvin probe force microscopy (Bruker Dimension Icon). The peaks of the functional groups were recorded by Fourier-transform infrared spectroscopy (NICOLET iS50) and X-ray photoelectron spectroscopy (Thermo Scientific K-Alpha). Thermogravimetric analysis was conducted in N₂ atmosphere with a temperature rise rate of 4° C. min⁻¹, using Mettler Toledo TGA-DSC 3+. Electric output signals were obtained using a linear motor with an exerted force of 12 N via finger bending-releasing and walking, and recorded using electrometer (Keithley 6514). EIS curves were recorded using electrochemical workstation (CHI 760E).

### REFERENCES

[1]A. Libanori, G. Chen, X. Zhao, Y. Zhou, J. Chen, Nat. Electron. 2022, 5, 142.
[2]Z. Liu, H. Li, B. Shi, Y. Fan, Z. L. Wang, Z. Li, Adv. Funct. Mater. 2019, 29, 1808820.
[3]C. Shi, Z. Zou, Z. Lei, P. Zhu, W. Zhang, J. Xiao, Sci. Adv., 2020, 6, eabd0202.
[4]M. Tan, Y. Xu, Z. Gao, T. Yuan, Q. Liu, R. Yang, B. Zhang, L. Peng, Adv. Mater. 2022, 34, 2108491.
[5]K. Meng, X. Xiao, W. Wei, G. Chen, A. Nashalian, S. Shen, X. Xiao, J. Chen, Adv. Mater. 2022, 34, 2109357.
[6]D. Hu, M. Yao, Y. Fan, C. Ma, M. Fan, M. Liu, Nano Energy 2019, 55, 288.
[7]Q. Xu, J. Wen, Y. Qin, Nano Energy 2021, 86, 106080.
[8]L. Fang, Q. Zheng, W. Hou, L. Zheng, H. Li, Nano Energy 2022, 97, 107164.
[9]M. T. Rahman, S. M. S. Rana, M. Salauddin, P. Maharjan, T. Bhatta, H. Kim, J. Y. Park, Appl. Energy 2020, 10, 115799.
[10]F. R. Fan, L. Lin, G. Zhu, W. Wu, R. Zhang, Z. L. Wang, Nano Lett. 2012, 12, 3109.
[11]S. A. Lone, K. C. Lim, K. Kaswan, S. Chatterjee, K.-P. Fan, D. Choi, S. Lee, H. Zhang, J. Cheng, Z.-H. Lin, Nano Energy 2022, 99, 107318.
[12]Y. Pang, Y. Cao, M. Derakhshani, Y. Fang, Z. L. Wang, C. Cao, Matter 2021, 4, 116.
[13]C. Zhang, W. Tang, C. Han, F. Fan, Z. L. Wang, Adv. Mater. 2014, 26, 3580.
[14]S. Cho, Y. Yun, S. Jang, Y. Ra, J. H. Choi, H. J. Hwang, D. Choi, D. Choi, Nano Energy 2020, 71, 104584.
[15]L. Liu, X. Yang, L. Zhao, W. Xu, J. Wang, Q. Yang, Q. Tang, Nano Energy 2020, 73, 104797.
[16]Y. Zou, V. Raveendran, J. Chen, Nano Energy 2020, 77, 105303.
[17]Y. Wu, Y. Li, Y. Zou, W. Rao, Y. Gai, J. Xue, L. Wu, X. Qu, Y. Liu, G. Xu, L. Xu, Z. Liu, Z. Li, Nano Energy 2022, 92, 106715.
[18]L. Wang, W. Liu, Z. Yan, F. Wang, X. Wang, Adv. Funct. Mater. 2020, 31, 2007221.
[19]L. Wang, Y. Wang, S. Yang, X. Tao, Y. Zi, W. A. Daoud, Nano Energy 2022, 91, 106611.
[20]M. He, W. Du, Y. Feng, S. Li, W. Wang, X. Zhang, A. Yu, L. Wan, J. Zhai, Nano Energy 2021, 86, 106058.
[21]Y. Qian, J. Nie, X. Ma, Z. Ren, J. Tian, J. Chen, H. Shen, X. Chen, Y. Li, Nano Energy 2019, 60, 493.
[22]B.-X. Cheng, C.-C. Lu, Q. Li, S.-Q. Zhao, C.-S. Bi, W. Wu, C.-X. Huang, H. Zhao, J. Polym. Environ. 2022, 30, 5252.
[23]Z. Bai, T. He, Z. Zhang, Y. Xu, Z. Zhang, Q. Shi, Y. Yang, B. Zhou, M. Zhu, J. Guo, C. Lee, Nano Energy 2022, 94, 106956.
[24]Z. Bai, Y. Xu, C. Lee, J. Guo, Adv. Funct. Mater. 2021, 31, 2104365.
[25]W. Yang, X. Lu, Adv. Mater. Technol. 2019, 4, 1900745.
[26]Y. Jia, Y. Pan, C. Wang, C. Liu, C. Shen, C. Pan, Z. Guo, X. Liu, Nanomicro. Lett. 2021, 13, 201.
[27]H. Chen, D. Adekoya, L. Hencz, J. Ma, S. Chen, C. Yan, H. Zhao, G. Cui, S. Zhang, Adv. Energy Mater. 2020, 10, 2000049.
[28]B. Yiming, Y. Han, Z. Han, X. Zhang, Y. Li, W. Lian, M. Zhang, J. Yin, T. Sun, Z. Wu, T. Li, J. Fu, Z. Jia, S. Qu, Adv. Mater. 2021, 33, e2006111.
[29]P. Zhang, W. Guo, Z. H. Guo, Y. Ma, L. Gao, Z. Cong, X. J. Zhao, L. Qiao, X. Pu, Z. L. Wang, Adv. Mater. 2021, 33, e2101396.
[30]Z. Xu, R. Li, H. Li, G. Gao, T. Chen, Soft Matter 2022, 18, 7103.
[31]Z. Li, P. Zhang, Y. Shao, Z.-H. Guo, X. Pu, Nano Res. 2023, 16, 11862.
[32]C. Dang, F. Zhang, Y. Li, Z. Jin, Y. Cheng, Y. Feng, X. Wang, C. Zhang, Y. Chen, C. Shao, Q. Zheng, H. Qi, Small 2022, 18, e2200421.
[33]T. Jing, S. Wang, H. Yuan, Y. Yang, M. Xue, B. Xu, Small 2023, 19, e2206528.
[34]B. Yiming, Y. Han, Z. Han, X. Zhang, Y. Li, W. Lian, M. Zhang, J. Yin, T. Sun, Z. Wu, T. Li, J. Fu, Z. Jia, S. Qu, Adv. Mater. 2021, 33, 2006111.
[35]P. Zhang, Y. Chen, Z. H. Guo, W. Guo, X. Pu, Z. L. Wang, Adv. Funct. Mater. 2020, 30, 1909252.
[36]M. Zhang, R. Yu, X. Tao, Y. He, X. Li, F. Tian, X. Chen, W. Huang, Adv. Funct. Mater. 2022, 33, 2208083.
[37]Y. Kim, D. Lee, J. Seong, B. Bak, U. H. Choi, J. Kim, Nano Energy 2021, 84, 105925.
[38]C. Li, P. Xue, L. Chen, J. Liu, Z. Wang, Compos. B. Eng. 2022, 234, 109729.
[39]M. Zhang, R. Yu, X. Tao, Y. He, X. Li, F. Tian, X. Chen, W. Huang, Adv. Funct. Mater. 2023, 33, 2208083.
[40]A. B. Afsar-Siddiqui, P. F. Luckham, O. K. Matar, Adv. Colloid Interface Sci. 2003, 106, 183.
[41]Y. He, P. Yazhgur, A. Salonen, D. Langevin, Adv. Colloid Interface Sci. 2015, 222, 377.
[42]D. Brutin, V. Starov, Chem. Soc. Rev. 2018, 47, 558.
[43]P. Alexandridis, S. Z. Munshi, Z. Gu, Ind. Eng. Chem. Res. 2011, 50, 580.
[44]M. Zhang, F. Song, X. L. Wang, Y. Z. Wang, Colloids Surf. B Biointerfaces 2012, 100, 16.
[45]D. C. Sinclair, A. R. West, J. Appl. Phys. 1989, 66, 3850.
[46]G. Cappelletti, C. L. Bianchi, S. Ardizzone, Appl. Surf. Sci. 2006, 253, 519.
[47]J. Gao, W.-Y. Wang, L.-T. Chen, L.-J. Cui, X.-Y. Hu, H.-Z. Geng, Appl. Surf. Sci. 2013, 277, 128.
[48]R. Xu, J. Liu, W. Sun, L. Wang, Sep. Purif. 2023, 310, 123049.
[49]C. Xu, Y. Zi, A. C. Wang, H. Zou, Y. Dai, X. He, P. Wang, Y. C. Wang, P. Feng, D. Li, Z. L. Wang, Adv. Mater. 2018, 30, e1706790.
[50]Z.-H. Lin, G. Cheng, Y. Yang, Y. S. Zhou, S. Lee, Z. L. Wang, Adv. Funct. Mater. 2014, 24, 2810-2816.
[51]A. Ahmed, M. F. El-Kady, I. Hassan, A. Negm, A. M. Pourrahimi, M. Muni, P. R. Selvaganapathy, R. B. Kaner, Nano Energy 2019, 59, 336.
[52]W. Zhang, Q. Liu, S. Chao, R. Liu, X. Cui, Y. Sun, H. Ouyang, Z. Li, ACS Appl. Mater. Interfaces 2021, 13, 42966.
[53]G. Jian, Q. Meng, Y. Jiao, L. Feng, H. Shao, F. Wang, F. Meng, Chem. Eng. J. 2021, 417, 127974.
[54]M. Li, H. W. Lu, S. W. Wang, R. P. Li, J. Y. Chen, W. S. Chuang, F. S. Yang, Y. F. Lin, C. Y. Chen, Y. C. Lai, Nat. Commun. 2022, 13, 938.
[55]Y. Jiang, K. Dong, X. Li, J. An, D. Wu, X. Peng, J. Yi, C. Ning, R. Cheng, P. Yu, Z. L. Wang, Adv. Funct. Mater. 2020, 31, 2005584.
[56]Y.-Y. Chen, T. S. T. Balamurugan, C.-Y. Chang, C.-Y. Hsu, C.-Y. Fang, Y.-S. Liu, L.-F. Ho, J. Mater. Chem. A 2023, 11, 10174.
[57]S. A. Graham, S. C. Chandrarathna, H. Patnam, P. Manchi, J.-W. Lee, J. S. Yu, Nano Energy 2021, 80, 105547.
[58]X. Qu, X. Ma, B. Shi, H. Li, L. Zheng, C. Wang, Z. Liu, Y. Fan, X. Chen, Z. Li, Z. L. Wang, Adv. Funct. Mater. 2020, 31, 2006612.
[59]G. Prasad, S. A. Graham, J. S. Yu, H. Kim, D.-W. Lee, Nano Energy 2023, 108, 108178.
[60]X. Bo, K. A. Uyanga, L. Wang, I. Firdous, J. Shi, W. Li, J. M. Almardi, M. Fahim, F. Liu, H. Lyu, W. A. Daoud, Chem. Eng. J. 2023, 451, 138714.
[61]Z. Bai, Z. Zhang, J. Li, J. Guo, Nano Energy 2019, 65, 104012.
[62]L. Wang, Y. Wang, X. Bo, H. Wang, S. Yang, X. Tao, Y. Zi, W. W. Yu, W. J. Li, W. A. Daoud, Adv. Funct. Mater. 2022, 32, 2270215.
[63]C. Li, P. Wang, D. Zhang, Nano Energy 2023, 109, 108285.
[64]K. Qin, C. Chen, X. Pu, Q. Tang, W. He, Y. Liu, Q. Zeng, G. Liu, H. Guo, C. Hu, Nano-Micro Lett. 2021, 13, 1.
[65]T. Jin, Z. Sun, L. Li, Q. Zhang, M. Zhu, Z. Zhang, G. Yuan, T. Chen, Y. Tian, X. Hou, C. Lee, Nat. Commun. 2020, 11, 5381.
[66]C. Ning, K. Dong, R. Cheng, J. Yi, C. Ye, X. Peng, F. Sheng, Y. Jiang, Z. L. Wang, Adv. Funct. Mater. 2021, 31, 2006679.
[67]Y. Luo, Z. Wang, J. Wang, X. Xiao, Q. Li, W. Ding, H. Y. Fu, Nano Energy 2021, 89, 106330.
[68]D. V. Anaya, M. R. Yuce, Med. Devices Sens. 2021, 4, 10154.
[69]S. Hajra, S. Panda, H. Khanberh, V. Vivekananthan, E. Chamanehpour, Y. K. Mishra, H. J. Kim, Nano Energy 2023, 115, 108729.
[70]G. Yao, L. Xu, X. Cheng, Y. Li, X. Huang, W. Guo, S. Liu, Z. L. Wang, H. Wu, Adv. Funct. Mater. 2020, 30, 1907312.
[71]Z. Xu, D. Zhang, H. Cai, Y. Yang, H. Zhang, C. Du, Nano Energy 2020, 102, 107719.
[72]X. Bo, W. Li, A. Valencia, H. Zhao, A. Budisuharto, W. A. Daoud, Nano Energy 2024, 119, 109085.
[73]J. Liao, Y. Zou, D. Jiang, Z. Liu, X. Qu, Z. Li, R. Liu, Y. Fan, B. Shi, Z. Li, L. Zheng, Nano Energy 2020, 69, 104417.
[74]P. Maharjan, T. Bhatta, M. Salauddin, M. S. Rasel, M. T. Rahman, S. M. S. Rana, J. Y. Park, Nano Energy 2020, 76, 105071.
[75]Z. Lu, L. Yang, Y. Guo, J. Power Sources 2006, 156, 555-559.

1. A triboelectric nanogenerator, comprising:
a negative electrode;
a negative tribolayer;
a positive tribolayer; and
a positive electrode;
wherein the positive tribolayer and the positive electrode are made of the same material; and
wherein the material is a surfactant-protected ionic conductive material.

2. A triboelectric nanogenerator as claimed in claim 1, wherein the surfactant-protected ionic conductive material comprises a stretchable polymer to which a surfactant and ionic salt are added.

3. A triboelectric nanogenerator as claimed in claim 2, wherein the stretchable polymer comprises one or a mixture of two or more of the following: Polyvinyl alcohol (PVA), Polyethylene glycol (PEG), Thermoplastic polyurethanes (TPU), water-based polyurethane (WPU), Polyimide (PI), lignin, cellulose, starch, chitin, and protein.

4. A triboelectric nanogenerator as claimed in claim 2, wherein the surfactant includes one or more of Formula I, II, III, IV, or V as shown: 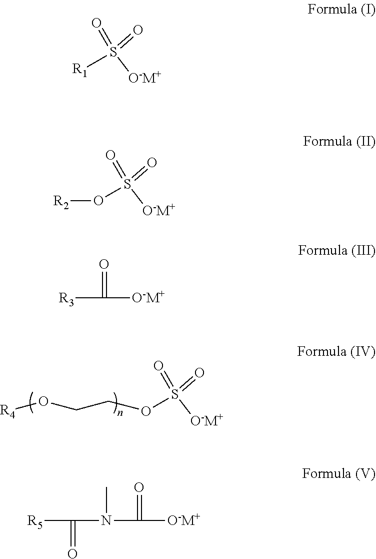
where
R₁, R₂, R₃, R₄, and R₅ independently represent a alkyl group, fluoroalkyl group, alkyl hydroxyl group, carbonyl group, alkylcarbonyl group or an ester group;
M⁺ independently represent metal ion.

5. A triboelectric nanogenerator as claimed in claim 4, wherein Formula (I-V) is selected from one or more of the following surfactants: sodium laureth sulfate, sodium lauroyl sarcosinate, sodium dodecylbenzene sulfonate, and sodium dodecyl sulfate.

6. A triboelectric nanogenerator as claimed in claim 2, wherein the surfactant-protected ionic conductive material is produced from a mixture in which ratio of the weight of surfactant to the polymer in the mixture is W_{surtactant}:W_{polymer}=1:20˜1:1.

7. A triboelectric nanogenerator as claimed in claim 6, wherein the ratio of the weight of surfactant to the polymer in the mixture is W_{surtactant}:W_{polymer}=1:10˜1:2.

8. A triboelectric nanogenerator as claimed in claim 2, the ionic salt has a formula of MₓN_{y}, wherein
M, which independently represents,
a metal element, Imidazolium, pyridinium, quaternary ammonium, quaternary phosphonium, Pyrrolidine and piperidine;
N, which represents:
halogen elements, nitrate, sulfate, carbonate, sulfite or hydroxide, borate, oxalate, difluorooxalate, bisoxalate borate, phosphate, fluorosulfonimide, alkylfluorosulfonimide, Trifluoromethanesulfonate, tetrafluoroborate, sulfonate, Alginate, Lignosulfonate, Carboxymethyl Cellulose.

9. A triboelectric nanogenerator as claimed in claim 8, wherein the ionic salt is selected from one or more of the following salt: 1-methylimidazole chloride, 1-methylimidazole trifluoromethanesulfonate, Lithium trifluorosulfonimide, Lithium Dimethylfluorosulfonimide.

10. A triboelectric nanogenerator as claimed in claim 2, wherein the surfactant-protected ionic conductive material is produced from a mixture in which the ratio of the weight of salt to the polymer is from 1:100 to 1:5 (as following): Wₛₐₗₜ:W_{polymer}=1:100˜1:5.

11. A triboelectric nanogenerator as claimed in claim 10, wherein the ratio is Wₛₐₗₜ:W_{polymer}=1:50˜1:10.

12. A triboelectric nanogenerator as claimed in claim 2, wherein the negative tribolayer is selected from a list comprising: Poly tetra fluoroethylene (PTFE), Fluorinated ethylene propylene (FEP), Silicon rubber, Polydimethylsiloxane (PDMS), Polyvinyl chloride (PVC), PVA (polyvinyl alcohol).

13. A triboelectric nanogenerator as claimed in claim 2, wherein the surfactant comprises an amphoteric surfactant.

14. A triboelectric nanogenerator as claimed in claim 2, wherein the surfactant is selected from one or more of the following: sodium lauryl sulfonate (SLS), sodium dodecyl sulfate (SDS), and sodium dodecyl benzene sulfonate (SDBS).

15. A triboelectric nanogenerator as claimed in claim 14, wherein the ionic salt comprises fluorine-containing ionic salt.

16. A triboelectric nanogenerator as claimed in claim 15, wherein the ionic salt comprises Lithium bis(trifluoromethanesulfonyl)imide (LiTFSI).

17. A method of fabricating a surfactant-protected ionic conductive material for a triboelectric nanogenerator, comprising the steps of:
a) preparing a mixture of a polymer, a surfactant, ionic salt and water;
b) stirring the mixture for a certain time;
c) providing the mixture into a mould and drying the mixture to form a film,
wherein the ratio of the weight of the surfactant to the polymer is W_{surfactant}:W_{polymer}=1:20˜1:1, and
wherein the ratio of the weight of the salt to the polymer is Wₛₐₗₜ:W_{polymer}=1:100˜1:5.

18. A method of fabricating a surfactant-protected ionic conductive material for a triboelectric nanogenerator as claimed in claim 17, wherein the mixture comprises the following:

| | | |
|---|---|---|
| WPU as polymer | 0.5 | g |
| Sodium laureth sulfate as | 0.1 | g |
| surfactant | | |
| 1-methylimidazole | 0.025 | g |
| chloride as ionic salt | | |
| water | 20 | ml |

and wherein
the step b) comprises stirring the mixture for 2 hours, and
the step c) comprises providing the mixture into a mould (dimension: length: 10 cm, width: 5 cm), and drying at 60° C. for 48 hours to form a film.

19. A method of fabricating a surfactant-protected ionic conductive material for a triboelectric nanogenerator as claimed in claim 17, wherein the mixture comprises WPS as the polymer, SDBS as the sulfactant, LiTFSI as the ionic salt, and wherein the step b) comprises stirring the mixture for half an hour to 2 hours, and the step c) comprises providing the mixture into a mould (dimension: diameter 9 cm), and drying at 60° C. for 12 hours to form a film.

20. A method of fabricating a triboelectric nanogenerator, comprising the steps of:
providing a surfactant-protected ionic conductive material layer as fabricated as claimed in claim 17, the surfactant-protected ionic conductive material layer forming a positive part;
providing a negative tribolayer and a negative electrode to form a negative part; and
attaching two pieces of foam between the positive part and the negative part to have a gap between the positive part and the negative part and to allow contact-separation between the positive part and the negative part.
